(19) United States
(12) Patent Application Publication
(10) Pub. No.: US 2026/0353338 A1
(43) Pub. Date: Nov. 5, 2026

(54) GROUP DELAY MARGINS FOR DEVICES WITH REFERENCE SIGNAL FREQUENCY HOPPING

(71) Applicant: QUALCOMM Incorporated, San Diego, CA (US)

(72) Inventors: Alexandros MANOLAKOS, Athens (GR); Carlos CABRERA MERCADER, Cardiff, CA (US); Tingfang JI, San Diego, CA (US)

(21) Appl. No.: 19/118,667

(22) PCT Filed: Oct. 11, 2023
(86) PCT No.: PCT/US2023/076575

§ 371 Date: Apr. 4, 2025

(30) Foreign Application Priority Data
Nov. 30, 2022 (GR) 20220100981

(51) Int. Cl. H04W 64/00; H04B 17/364; H04L 5/00

(52) U.S. Cl. CPC H04W 64/00; H04B 17/364; H04L 5/0012; H04L 5/0051

(57) ABSTRACT

In an aspect, a user equipment (UE) may determine an aggregated bandwidth corresponding to a total bandwidth of multiple reference signals (RS) transmitted used in frequency hopping positioning session. The UE may determine a tuned bandwidth of the UE for transmitting or receiving the RS. The UE may determine, as a group delay margin for the positioning session, a first group delay margin from a set of preconfigured group delay margins based on the tuned bandwidth being less than or equal to the aggregated bandwidth. The UE may determine, as the group delay margin for the Frequency positioning session, a second group delay margin based on the aggregated bandwidth being greater than the tuned bandwidth. The UE may transmit or measuring the multiple RS based on the first group delay margin or the second group delay margin for the positioning session.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes determining an aggregated bandwidth corresponding to a total bandwidth of multiple reference signals (RS) transmitted based on frequency hopping the RS to different frequency ranges during a positioning session; determining a tuned bandwidth of the UE for transmitting or receiving the RS; determining, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth; determining, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and transmitting or measuring the multiple RS based on the first group delay margin or the second group delay margin for the positioning session.

In an aspect, a method of wireless communication performed by a user equipment (UE) includes receiving a configuration for transmitting or receiving multiple reference signals (RS) during a positioning session based on frequency hopping the RS to different frequency ranges; determining a tuned bandwidth of the UE for transmitting or receiving the RS; transmitting, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and transmitting, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

In an aspect, a user equipment (UE) includes a memory; at least one transceiver; and at least one processor communicatively coupled to the memory and the at least one transceiver, the at least one processor configured to: determine an aggregated bandwidth corresponding to a total bandwidth of multiple reference signals (RS) transmitted based on frequency hopping the RS to different frequency ranges during a positioning session; determine a tuned bandwidth of the UE for transmitting or receiving the RS; determine, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth; determine, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and transmit, via the at least one transceiver, or measuring the multiple RS based on the first group delay margin or the second group delay margin for the positioning session.

In an aspect, a user equipment (UE) includes a memory; at least one transceiver; and at least one processor communicatively coupled to the memory and the at least one transceiver, the at least one processor configured to: receive, via the at least one transceiver, a configuration for transmitting or receiving multiple reference signals (RS) during a positioning session based on frequency hopping the RS to different frequency ranges; determine a tuned bandwidth of the UE for transmitting or receiving the RS; transmit, via the at least one transceiver, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and transmit, via the at least one transceiver, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

In an aspect, a user equipment (UE) includes means for determining an aggregated bandwidth corresponding to a total bandwidth of multiple reference signals (RS) transmitted based on frequency hopping the RS to different frequency ranges during a positioning session; means for determining a tuned bandwidth of the UE for transmitting or receiving the RS; means for determining, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth; means for determining, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and means for transmitting or measuring the multiple RS based on the first group delay margin or the second group delay margin for the positioning session.

In an aspect, a user equipment (UE) includes means for receiving a configuration for transmitting or receiving multiple reference signals (RS) during a positioning session based on frequency hopping the RS to different frequency ranges; means for determining a tuned bandwidth of the UE for transmitting or receiving the RS; means for transmitting, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and means for transmitting, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

In an aspect, a non-transitory computer-readable medium stores computer-executable instructions that, when executed by a user equipment (UE), cause the UE to: determine an aggregated bandwidth corresponding to a total bandwidth of multiple reference signals (RS) transmitted based on frequency hopping the RS to different frequency ranges during a positioning session; determine a tuned bandwidth of the UE for transmitting or receiving the RS; determine, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth; determine, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and transmit or measuring the multiple RS based on the first group delay margin or the second group delay margin for the positioning session.

In an aspect, a non-transitory computer-readable medium stores computer-executable instructions that, when executed by a user equipment (UE), cause the UE to: receive a configuration for transmitting or receiving multiple reference signals (RS) during a positioning session based on frequency hopping the RS to different frequency ranges; determine a tuned bandwidth of the UE for transmitting or receiving the RS; transmit, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and transmit, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 illustrates an example Long-Term Evolution (LTE) positioning protocol (LPP) call flow between a UE and a location server for performing positioning operations.

FIG. 6 is a diagram illustrating an example round-trip-time (RTT) procedure for determining a location of a UE, according to aspects of the disclosure.

FIG. 7 is a diagram showing example timings of RTT measurement signals exchanged between a base station and a UE, according to aspects of the disclosure.

FIG. 8 is a diagram illustrating example timings of RTT measurement signals exchanged between a base station and a UE, according to aspects of the disclosure.

FIG. 9 depicts timing errors (e.g., group delays) associated with two transmission-reception points (TRPs) receiving the same reference signal, according to aspects of the disclosure.

FIG. 10 shows tables that may be used to illustrate the contribution of timing errors to positioning measurement accuracy, according to aspects of the disclosure.

FIG. 11 shows tables illustrating group delay calibration margin candidates for UE reception-transmission (Rx-Tx) measurement accuracy with respect to RS bandwidth, according to aspects of the disclosure.

FIG. 12 illustrates an evaluation of phase offset for a two-hop scenario, according to aspects of the disclosure.

FIG. 13 illustrates an evaluation of phase offset for an eight-hop scenario, according to aspects of the disclosure.

FIG. 14 depicts a frequency hopping scenario that may be analyzed to determine a group delay margin for use in the corresponding positioning session, according to aspects of the disclosure.

FIG. 15 depicts another frequency hopping scenario that may be analyzed to determine a group delay margin for use in the corresponding positioning session, according to aspects of the disclosure.

FIG. 16 depicts another frequency hopping scenario that may be analyzed to determine a group delay margin for use in the corresponding positioning session, according to aspects of the disclosure.

FIG. 17 depicts another frequency hopping scenario that may be analyzed to determine a group delay margin for use in the corresponding positioning session, according to aspects of the disclosure.

FIG. 18 depicts another frequency hopping scenario that may be analyzed to determine a group delay margin for use in the corresponding positioning session, according to aspects of the disclosure.

FIG. 19 illustrates an example method of wireless communication that may be performed by a UE, according to aspects of the disclosure.

FIG. 20 illustrates an example method of wireless communication that may be performed by a UE, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (loT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station, Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

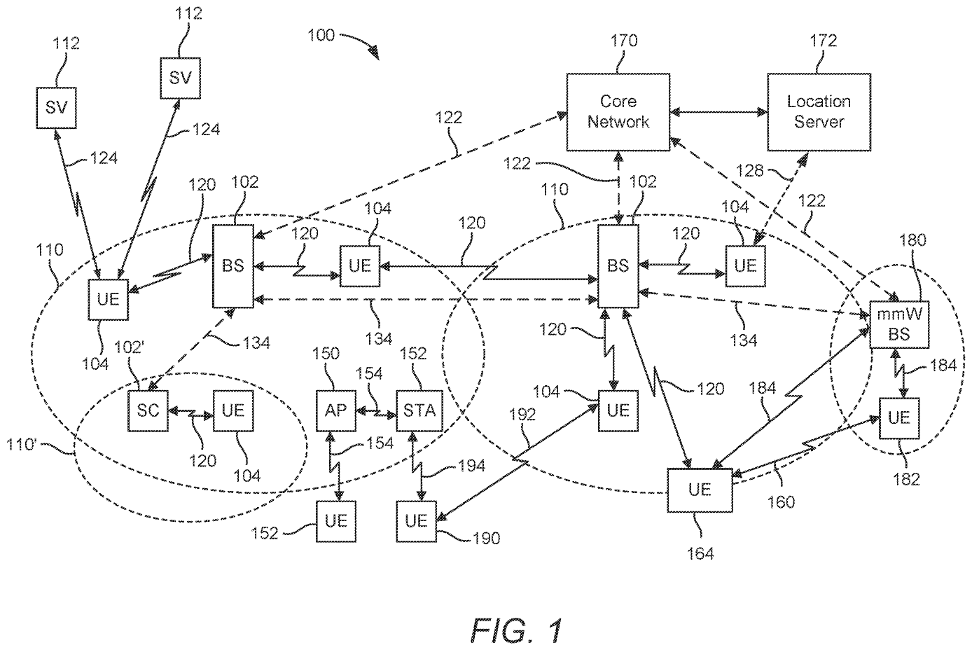

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local arca network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mm W frequencies and/or near mm W frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming. the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mm W base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.1 1x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. I only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102″, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in tum provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 bas a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

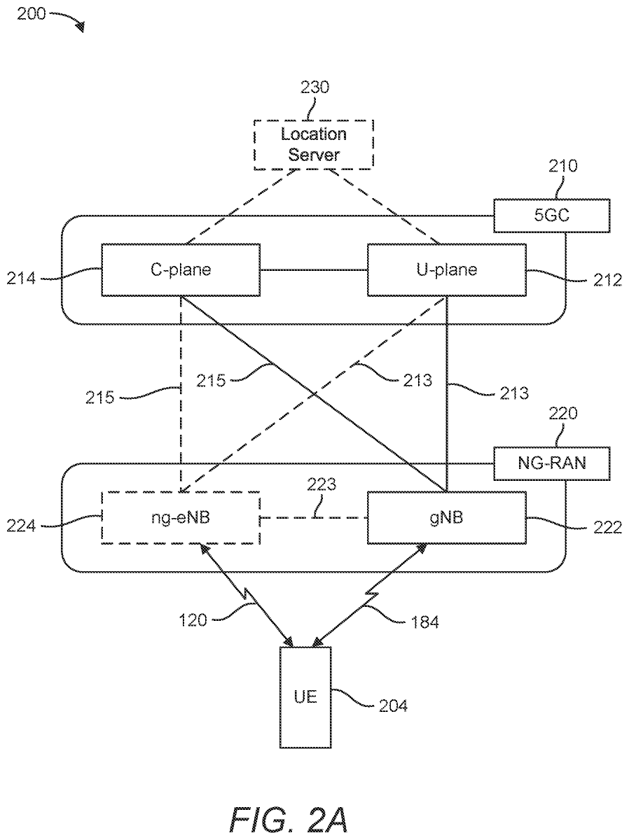

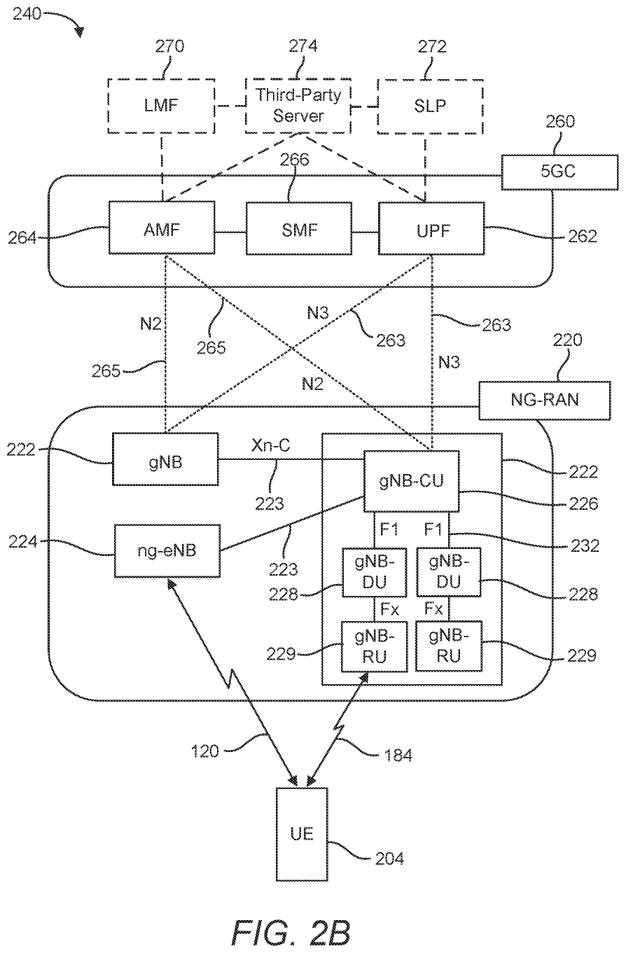

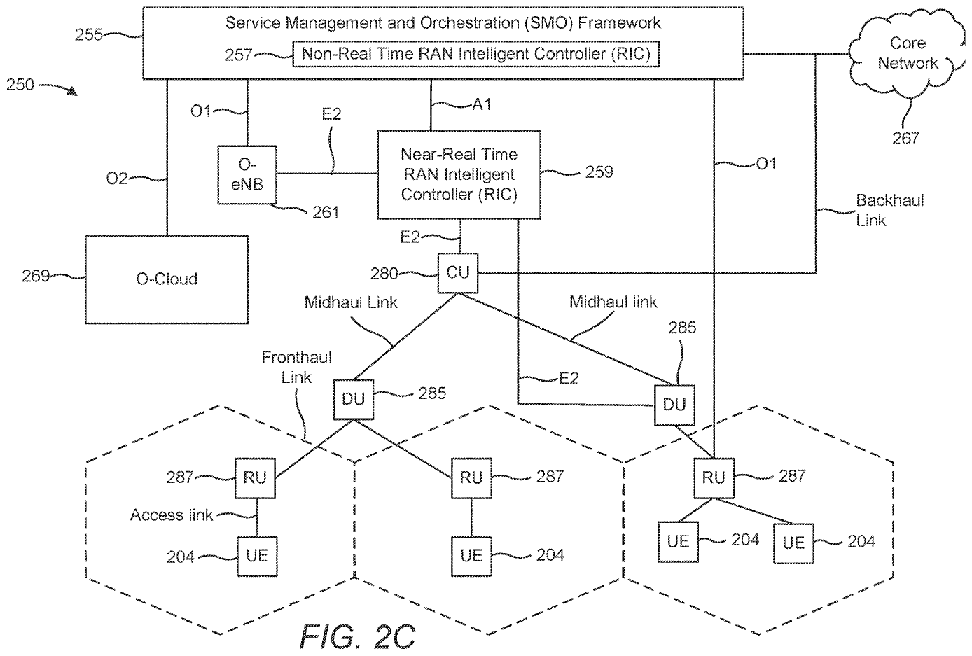

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF), The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement. reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host. one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an Al interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as Al policies).

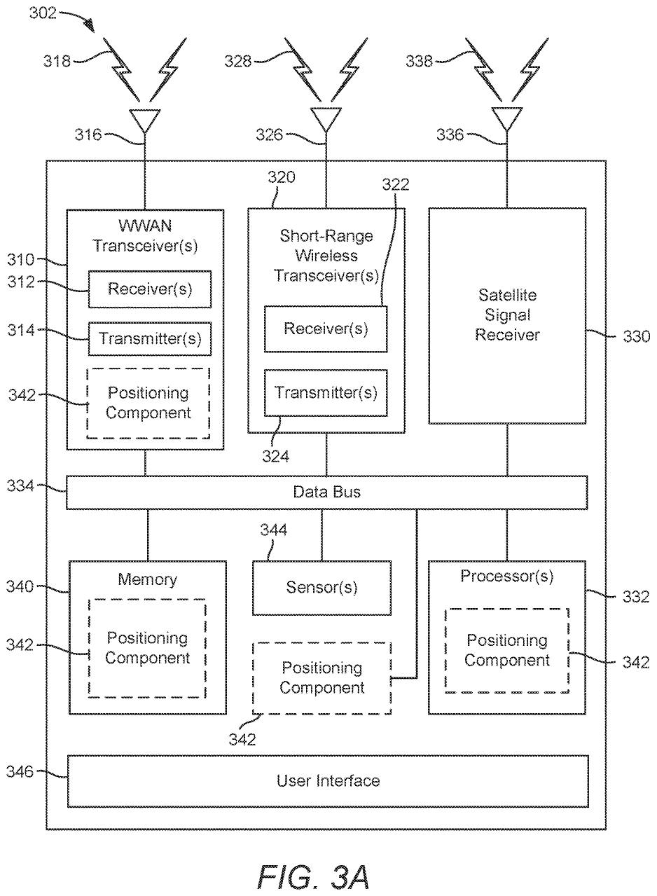

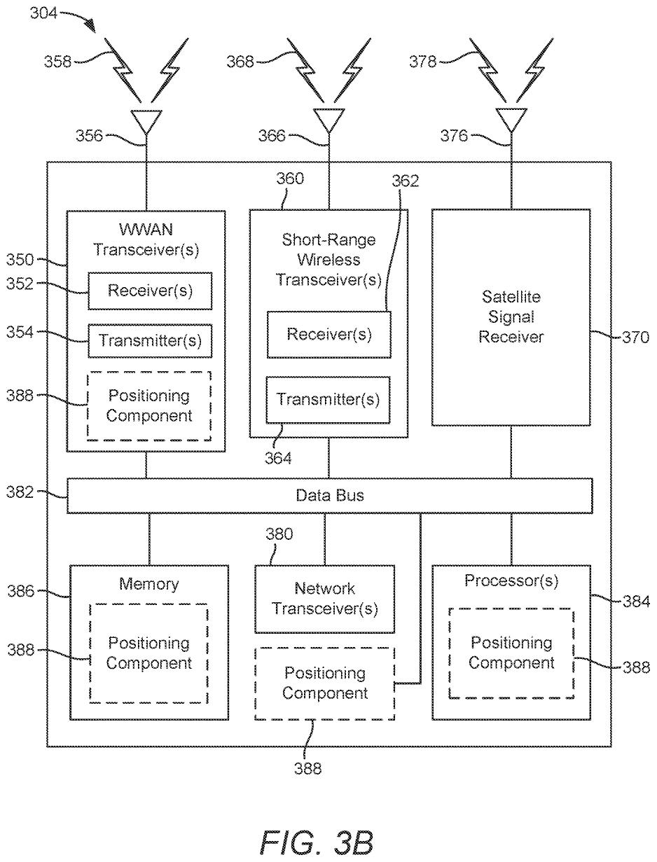

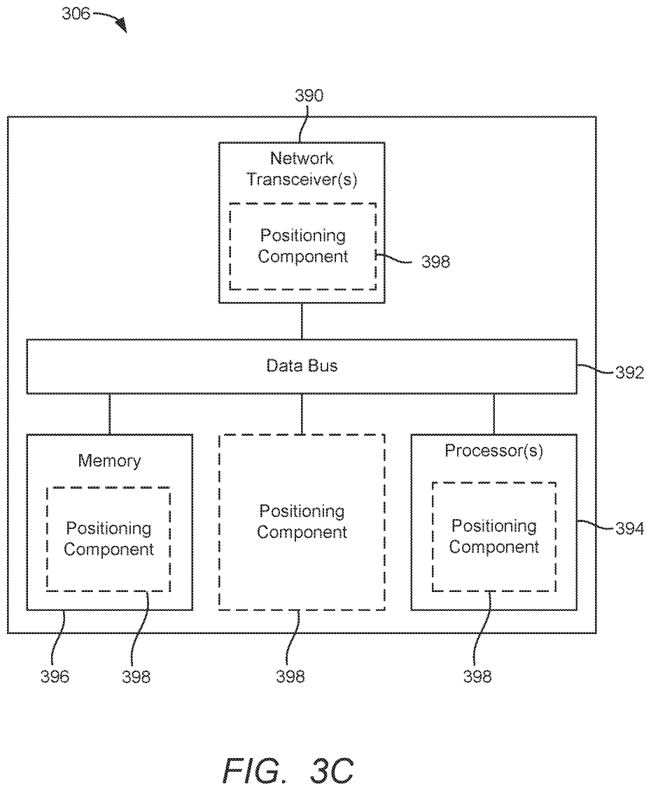

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®), Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link, A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-I functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality, In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

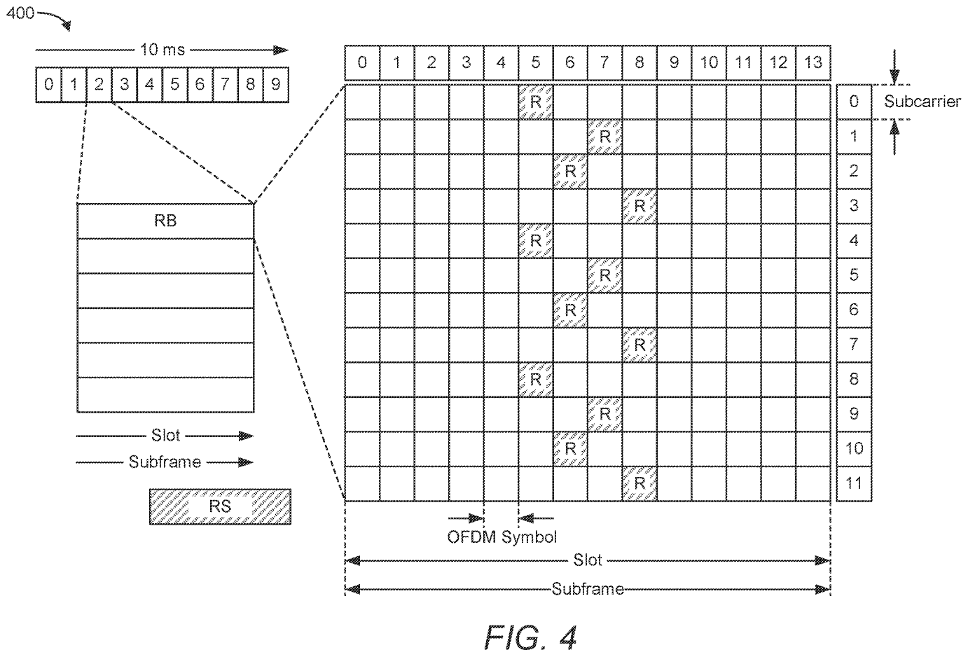

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4 K FFT size is 50. For 30 kHz SCS (μ=1), there are two slots per subframe, 20 slots per frame, the slot duration is 0.5 ms, the symbol duration is 33.3 us, and the maximum nominal system bandwidth (in MHz) with a 4 K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4 K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4 K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4 K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration, Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 4); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.” A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc.

In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

The E-CID positioning method is based on radio resource management (RRM) measurements, In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (us). In some cases, when any of the resources used for the positioning measurement are in FR1, the value range for the uncertainty of the expected RSTD may be +/−32 ps. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location, A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

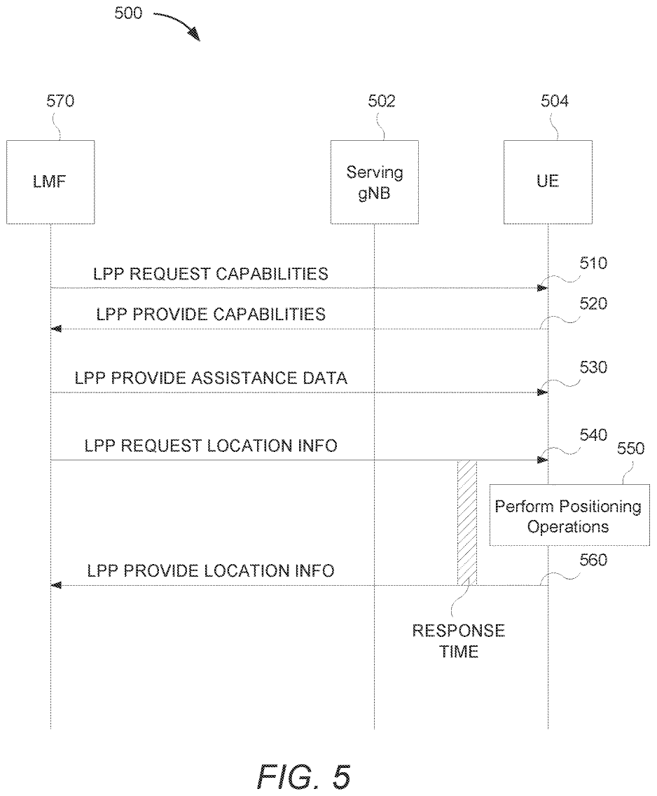

FIG. 5 illustrates an example Long-Term Evolution (LTE) positioning protocol (LPP) procedure 500 between a UE 504 and a location server (illustrated as a location management function (LMF) 570) for performing positioning operations. As illustrated in FIG. 5, positioning of the UE 504 is supported via an exchange of LPP messages between the UE 504 and the LMF 570. The LPP messages may be exchanged between UE 504 and the LMF 570 via the UE's 504 serving base station (illustrated as a serving gNB 502) and a core network (not shown). The LPP procedure 500 may be used to position the UE 504 in order to support various location-related services, such as navigation for UE 504 (or for the user of UE 504), or for routing, or for provision of an accurate location to a public safety answering point (PSAP) in association with an emergency call from UE 504 to a PSAP, or for some other reason. The LPP procedure 500 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 504 may receive a request for its positioning capabilities from the LMF 570 at stage 510 (e.g., an LPP Request Capabilities message). At stage 520, the UE 504 provides its positioning capabilities to the LMF 570 relative to the LPP protocol by sending an LPP Provide Capabilities message to LMF 570 indicating the position methods and features of these position methods that are supported by the UE 504 using LPP. The capabilities indicated in the LPP Provide Capabilities message may, in some aspects, indicate the type of positioning the UE 504 supports (e.g., DL-TDOA, RTT, E-CID, etc.) and may indicate the capabilities of the UE 504 to support those types of positioning.

Upon reception of the LPP Provide Capabilities message, at stage 520, the LMF 570 determines to use a particular type of positioning method (e.g., DL-TDOA, RTT, E-CID, etc.) based on the indicated type(s) of positioning the UE 504 supports and determines a set of one or more transmission-reception points (TRPs) from which the UE 504 is to measure downlink positioning reference signals or towards which the UE 504 is to transmit uplink positioning reference signals. At stage 530, the LMF 570 sends an LPP Provide Assistance Data message to the UE 504 identifying the set of TRPs.

In some implementations, the LPP Provide Assistance Data message at stage 530 may be sent by the LMF 570 to the UE 504 in response to an LPP Request Assistance Data message sent by the UE 504 to the LMF 570 (not shown in FIG. 5). An LPP Request Assistance Data message may include an identifier of the UE's 504 serving TRP and a request for the positioning reference signal (PRS) configuration of neighboring TRPs.

At stage 540, the LMF 570 sends a request for location information to the UE 504. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 530 may be sent after the LPP Request Location Information message at 540 if, for example, the UE 504 sends a request for assistance data to LMF 570 (e.g., in an LPP Request Assistance Data message, not shown in FIG. 5) after receiving the request for location information at stage 540.

At stage 550, the UE 504 utilizes the assistance information received at stage 530 and any additional data (e.g., a desired location accuracy or a maximum response time) received at stage 540 to perform positioning operations (e.g., measurements of DL-PRS, transmission of UL-PRS, etc.) for the selected positioning method.

At stage 560, the UE 504 may send an LPP Provide Location Information message to the LMF 570 conveying the results of any measurements that were obtained at stage 550 (e.g., time of arrival (ToA), reference signal time difference (RSTD), reception-to-transmission (Rx-Tx), etc.) and before or when any maximum response time has expired (e.g., a maximum response time provided by the LMF 570 at stage 540). The LPP Provide Location Information message at stage 560 may also include the time (or times) at which the positioning measurements were obtained and the identity of the TRP(s) from which the positioning measurements were obtained. Note that the time between the request for location information at 540 and the response at 560 is the “response time” and indicates the latency of the positioning session.

The LMF 570 computes an estimated location of the UE 504 using the appropriate positioning techniques (e.g., DL-TDOA, RTT, E-CID, etc.) based, at least in part, on measurements received in the LPP Provide Location Information message at stage 560.

In NR, there may not be precise timing synchronization across the network. Instead, it may be sufficient to have coarse time-synchronization across base stations (e.g., within a cyclic prefix (CP) duration of the orthogonal frequency division multiplexing (OFDM) symbols). RTT-based methods generally only need coarse timing synchronization, and as such, are a preferred positioning method in NR.

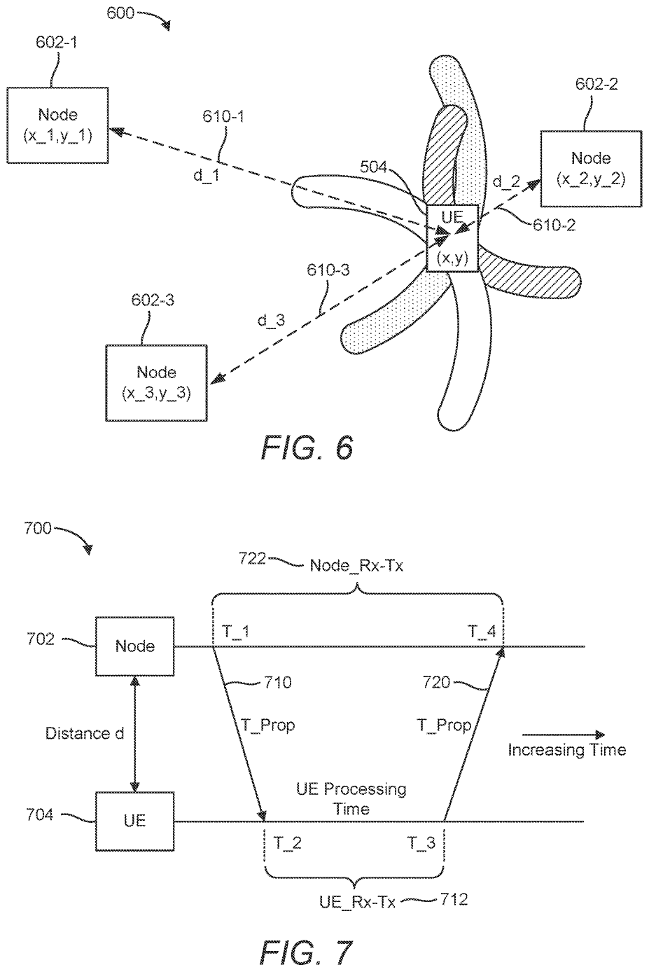

FIG. 6 illustrates an example wireless communications system 600, according to aspects of the disclosure. In the example of FIG. 6, a UE 604 (e.g., any of the UEs described herein) is attempting to calculate an estimate of its location, or assist another entity (e.g., a base station or core network component, another UE, a location server, a third party application, etc.) to calculate an estimate of its location. The UE 604 may transmit and receive wireless signals to and from a plurality of network nodes (labeled “Node”) 602-1, 602-2, and 602-3 (collectively, network nodes 602). The network nodes 602 may include one or more base stations (e.g., any of the base stations described herein), one or more reconfigurable intelligent displays (RIS), one or more positioning beacons, one or more UEs (e.g., connected over sidelinks), etc.

In a network-centric RTT positioning procedure the serving base station (e.g., one of network nodes 602) instructs the UE 604 to measure RTT measurement signals (e.g., PRS) from two or more neighboring network nodes 602 (and typically the serving base station, as at least three network nodes 602 are needed for a two-dimensional location estimate). The involved network nodes 602 transmit RTT measurement signals on low reuse resources (e.g., resources used by the network nodes 602 to transmit system information, where the network nodes 602 are base stations) allocated by the network (e.g., location server 230, LMF 270, SLP 272). The UE 604 records the arrival time (also referred to as the receive time, reception time, time of reception, or time of arrival) of each RTT measurement signal relative to the UE's 604 current downlink timing (e.g., as derived by the UE 604 from a downlink signal received from its serving base station), and transmits a common or individual RTT response signal (e.g., SRS) to the involved network nodes 602 on resources allocated by its serving base station, The UE 604, if it not the positioning entity, reports a UE reception-to-transmission (Rx-Tx) time difference measurement to the positioning entity. The UE Rx-Tx time difference measurement indicates the time difference between the arrival time of each RTT measurement signal at the UE 604 and the transmission time(s) of the RTT response signal(s). Each involved network node 602 also reports, to the positioning entity, a network node Rx-Tx time difference measurement (also referred to as a base station (BS) or gNB Rx-Tx time difference measurement), which indicates the difference between the transmission time of the RTT measurement signal and the reception time of the RTT response signal.

A UE-centric RTT positioning procedure is similar to the network-based procedure, except that the UE 604 transmits uplink RTT measurement signal(s) (e.g., on resources allocated by the serving base station). The uplink RTT measurement signal(s) are measured by multiple network nodes 602 in the neighborhood of the UE 604. Each involved network node 602 responds with a downlink RTT response signal and reports a network node Rx-Tx time difference measurement to the positioning entity. The network node Rx-Tx time difference measurement indicates the time difference between the arrival time of the RTT measurement signal at the network node 602 and the transmission time of the RTT response signal. The UE 604, if it is not the positioning entity, reports, for each network node 602, a UE Rx-Tx time difference measurement that indicates the difference between the transmission time of the RTT measurement signal and the reception time of the RTT response signal.

In order to determine the location (x, y) of the UE 604, the positioning entity needs to know the locations of the network nodes 602, which may be represented in a reference coordinate system as (x_k, y_y), where k=1, 2, 3 in the example of FIG. 6. Where the UE 604 is the positioning entity, a location server with knowledge of the network geometry (e.g., location server 230, LMF 270, SLP 272) may provide the locations of the involved network nodes 602 to the UE 604.

The positioning entity determines each distance 610 (d_k, where k=1, 2, 3) between the UE 604 and the respective network node 602 based on the UE Rx-Tx and network node Rx-Tx time difference measurements and the speed of light, as described further below with reference to FIG. 7. Specifically, in the example of FIG. 6, the distance 610-1 between the UE 604 and the network node 602-1 is d_1, the distance 610-2 between the UE 604 and the network node 602-2 is d_2, and the distance 610-3 between the UE 604 and the network node 602-3 is d_3. Once each distance 610 is determined, the positioning entity can solve for the location (x, y) of the UE 604 by using a variety of known geometric techniques, such as trilateration. From FIG. 6, it can be seen that the location of the UE 604 ideally lies at the common intersection of three semicircles, each semicircle being defined by radius dk and center (x_k, y_k), where k=1, 2, 3.

FIG. 7 is a diagram 700 showing example timings of RTT measurement signals exchanged between a network node 702 (labeled “Node”) and a UE 704, according to aspects of the disclosure. The UE 704 may be any of the UEs described herein. The network node 702 may be a base station (e.g., any of the base stations described herein), an RIS, a positioning beacon, another UE (e.g., connected over a sidelink), or the like.

In the example of FIG. 7, the network node 702 (labeled “BS”) sends an RTT measurement signal 710 (e.g., PRS) to the UE 704 at time T_1. The RTT measurement signal 710 has some propagation delay T_Prop as it travels from the network node 702 to the UE 704. At time T_2 (the reception time of the RTT measurement signal 710 at the UE 704), the UE 704 measures the RTT measurement signal 710. After some UE processing time, the UE 704 transmits an RTT response signal 720 (e.g., SRS) at time T_3. After the propagation delay T_Prop, the network node 702 measures the RTT response signal 720 from the UE 704 at time T_4 (the reception time of the RTT response signal 720 at the network node 702), The UE 704 reports the difference between time T_3 and time T_2 (i.e., the UE's 704 Rx-Tx time difference measurement, shown as UE_Rx-Tx 712) to the positioning entity. Similarly, the network node 702 reports the difference between time T_4 and time T_1 (i.e., the network node's 702 Rx-Tx time difference measurement, shown as Node_Rx-Tx 722) to the positioning entity. Using these measurements and the known speed of light, the positioning entity can calculate the distance to the UE 704 as d=½*c*(Node_Rx-Tx−UE_Rx-Tx)=½*c*(T_4−T_1)−½*c*(T_3−T_2), where c is the speed of light.

Based on the known location of the network node 702 and the distance between the UE 704 and the network node 702 (and at least two other network nodes 702), the positioning entity can calculate the location of the UE 704. As shown in FIG. 6, the location of the UE 704 lies at the common intersection of three semicircles, each semicircle being defined by a radius of the distance between the UE 704 and a respective network node 702.

In an aspect, the positioning entity may calculate the UE's 604/704 location using a two-dimensional coordinate system; however, the aspects disclosed herein are not so limited, and may also be applicable to determining locations using a three-dimensional coordinate system, if the extra dimension is desired. Additionally, while FIG. 6 illustrates one UE 604 and three network nodes 602 and FIG. 7 illustrates one UE 704 and one network node 702, as will be appreciated, there may be more UEs 604/704 and more network nodes 602/702.

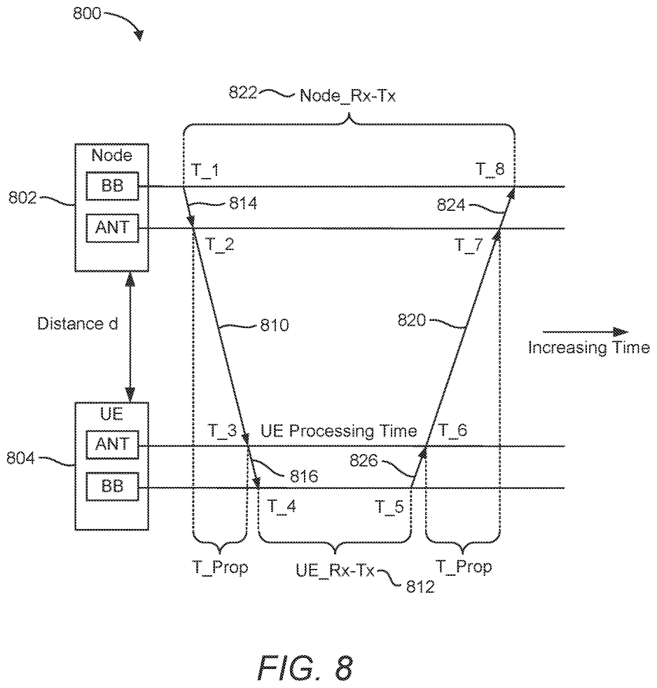

FIG. 8 is a diagram 800 showing example timings of RTT measurement signals exchanged between a network node 802 and a UE 804, according to aspects of the disclosure. The diagram 800 is similar to the diagram 700, except that it includes processing delays that may occur at both the network node 802 (labeled “Node”) and the UE 804 when transmitting and receiving the RTT measurement and response signals. The network node 802 may be a base station (e.g., any of the base stations), an RIS (e.g., RIS 410), another UE (e.g., any of the UEs described herein), or other network node capable of performing an RTT positioning procedure. As a specific example, the network node 802 and the UE 804 may correspond to the base station 702 and the UE 704 in FIG. 7.

Referring now to potential processing delays, at the network node 802, there is a transmission delay 814 between the time T_1 that the network node's 802 baseband (labeled “BB”) generates the RTT measurement signal 810 (e.g., a PRS) and the time T_2 that the network node's 802 antenna(s) (labeled “Ant”) transmit the RTT measurement signal 810. At the UE 804, there is a reception delay 816 between the time T_3 that the UE's 604 antenna(s) (labeled “Ant”) receive the RTT measurement signal 810 and the time T_4 that the UE's 804 baseband (labeled “BB”) processes the RTT measurement signal 810.

Similarly, for the RTT response signal 820 (e.g., an SRS), there is a transmission delay 826 between the time T_5 that the UE's 804 baseband generates the RTT response signal 820 and the time T_6 that the UE's 804 antenna(s) transmit the RTT response signal 820. At the network node 802, there is a reception delay 824 between the time T_7 that the network node's 802 antenna(s) receive the RTT response signal 820 and the time T_8 that the network node's 802 baseband processes the RTT response signal 820.

The difference between times T_2 and T_1 (i.e., transmission delay 814) and times T_8 and T_7 (i.e., reception delay 824) is referred to as the network node's 802 “group delay.” The difference between times T_4 and T_3 (i.e., reception delay 816) and times T_6 and T_5 (i.e., transmission delay 826) is referred to as the UE's 804 “group delay.” The group delay includes a hardware group delay, a group delay attributable to software/firmware, or both. More specifically, although software and/or firmware may contribute to group delay, the group delay is primarily due to internal hardware delays between the baseband and the antenna(s) of the network node 802 and the UE 804.

As shown in FIG. 8, because of the reception delay 816 and the transmission delay 826, the UE's 804 Rx-Tx time difference measurement 812 does not represent the difference between the actual reception time at time T_3 and the actual transmission time at time T_6. Similarly, because of the transmission delay 814 and the reception delay 824, the network node's 802 Rx-Tx time difference measurement 822 does not represent the difference between the actual transmission time at time T_2 and the actual reception time at time T_7. Thus, as shown, group delays, such as reception delays 816 and 824 and transmission delays 814 and 826, can contribute to timing errors and/or calibration errors that can impact RTT measurements, as well as other measurements, such as TDOA, RSTD, etc. This can in turn can impact positioning performance. For example, in some designs, a 10 ns error will introduce three meters of error in the final location estimate.

In some cases, the UE 804 can calibrate its group delay and compensate for it so that the UE Rx-Tx time difference measurement 812 reflects the actual reception and transmission times from its antenna(s). Alternatively, the UE 804 can report its group delay to the positioning entity (if not the UE 804), which can then subtract the group delay from the UE Rx-Tx time difference measurement 812 when determining the final distance between the network node 802 and the UE 804. Similarly, the network node 802 may be able to compensate for its group delay in the network node Rx-Tx time difference measurement 822, or simply report the group delay to the positioning entity.

Transmission/reception timing errors have been defined in NR standards for a UE. Such timing errors have been defined as the uncalibrated Tx/Rx group delay (e.g., reception delay 816 and transmission delay 826) between baseband and the Tx/Rx antenna, or the residual error of the Tx/Rx group delay between baseband and the Tx/Rx antenna after calibration, if the UE implements such calibration.

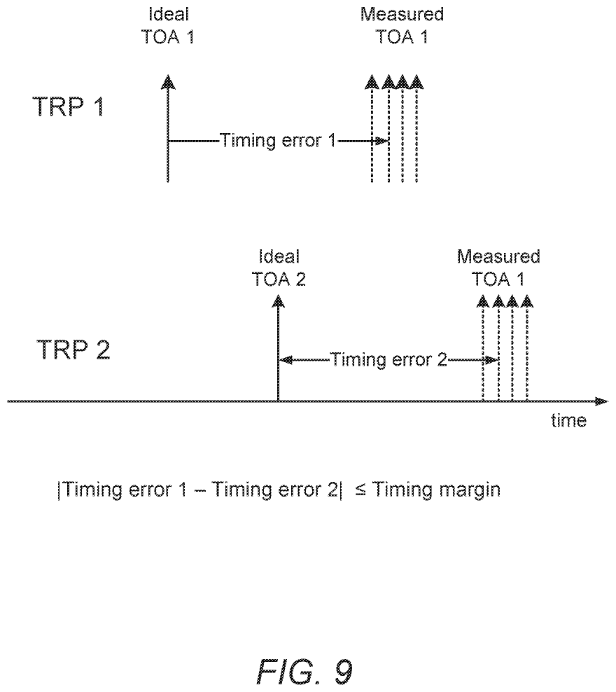

Timing error groups (TEGs) can help mitigate the impact of Tx/Rx timing errors using differential processing. An Rx TEG is a grouping of time-of-arrival measurements obtained from one or more RS resources, such that the difference between the Rx timing errors for any two measurements belonging to the same Rx TEG is within a certain margin. FIG. 9 depicts timing errors (e.g., group delays) associated with two TRPs. labeled TRP 1 and TRP 2, receiving the same reference signal, according to aspects of the disclosure. In this example, TRP 1 receives the reference signal at time TOA 1 (ideal time) with an associated measured TOA 1 with a timing error, labeled Timing error 1, corresponding to the timing error associated with TRP 1. Similarly, TRP 2 receives the reference signal at time TOA 2 (ideal time) with an associated measured TOA 2 having a timing error, labeled Timing error 1, corresponding to the timing error associated with TRP 1. TRP 1 and TRP 2 are within the same Rx TEG if

|Timing error 1−Timing error 2|≤Timing margin

where the Timing Margin is determined based on preconfigured timing margin requirements (e.g., standardized timing margins).

There are also other TEGs that may be used to mitigate the impact of Tx/Rx timing errors using differential processing. The RxTx TEG is a grouping of RxTx measurements obtained from one or more RS resources, such that the difference between the RxTx timing errors for any two measurements belonging to the same RxTx TEG is within a certain margin. A Tx TEG is a grouping of RS resource transmissions, such that the difference between the Tx timing errors for any two transmissions belonging to the same Tx TEG is within a certain margin.

In accordance with aspects of the disclosure, the association of measurements/transmissions with TEGs is based on UE/TRP implementation. Reporting of TEGs by a UE is optional even if the UE supports the feature. In an aspect, UE Rx TEG and UE Rx-Tx TEG associations can be reported for UE-assisted DL-TDOA and RTT positioning. In an aspect, the association to an Rx/Rx-Tx TEG ID is valid within one measurement report and may apply only to the measurements that are tagged with the corresponding TEG ID. In an aspect, UE Tx TEG associations can be reported for UL-TDOA and RTT positioning. In an aspect, the associations to a Tx TEG ID may be valid within a time period reported to the LMF (or gNB) using time stamps.

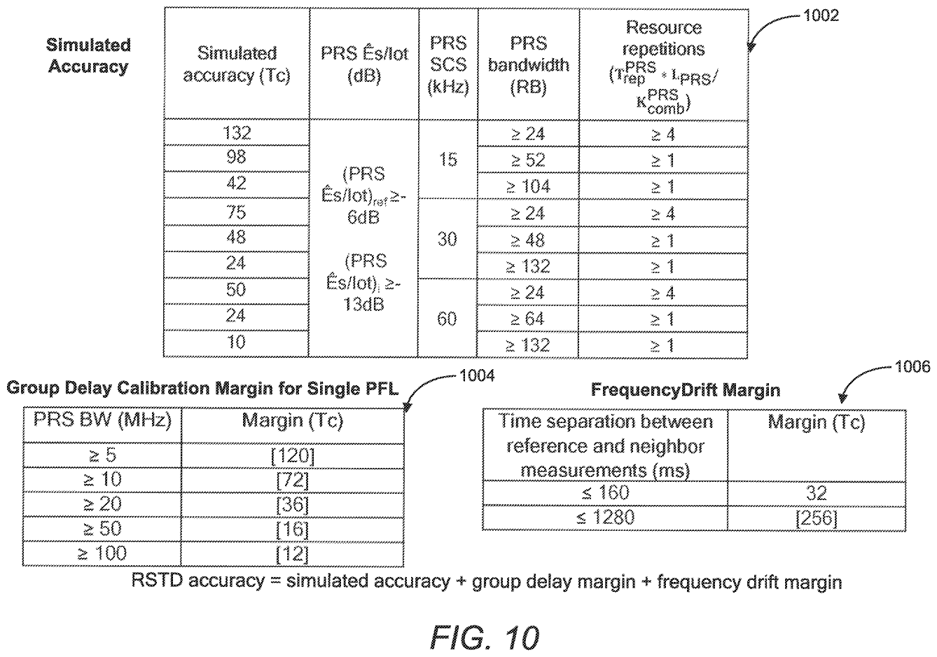

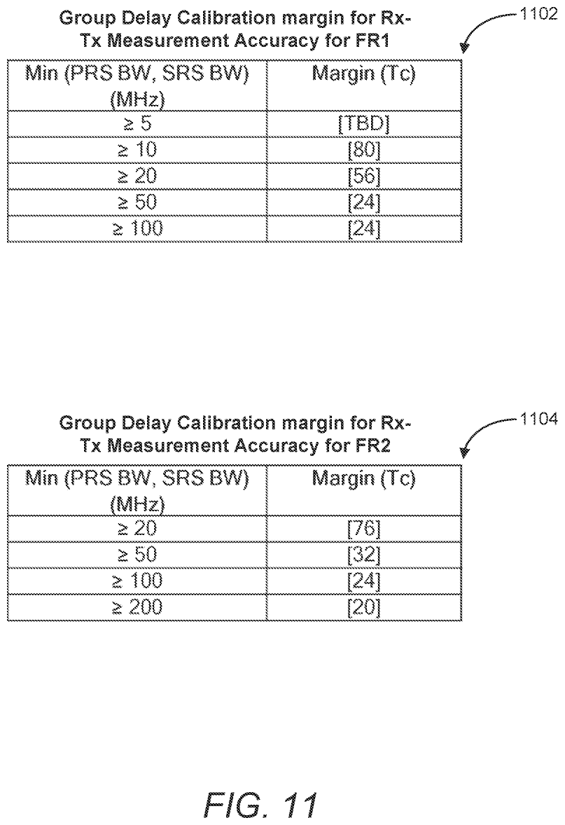

FIG. 10 shows tables that may be used to illustrate the contribution of timing errors to positioning measurement accuracy, according to aspects of the disclosure. In this example, the contributions of timing errors to the measurement accuracy are shown in the context of RSTD positioning in Additive White Gaussian Noise (AWGN) for FR1. The RSTD accuracy may be expressed as:

RSTD accuracy=simulated accuracy+group delay margin+frequency drift margin
where
simulated accuracy is selected from the conditions shown in Table 1002,
group delay margin is selected based on the conditions shown in Table 1004, and
frequency drift margin is selected based on the conditions shown in Table 1006.

Tables 1002, 1004, and 1006 express the timing in terms of the standardized timing unit Te (currently standardized at Tc=0.509 ns). Based on a PRS having a bandwidth of 100 MHz, and assuming≤160 msec time separation:

RSTD accuracy=10 Tc+12 Tc+32 Te=54 Tc=27.486 ns

Timing error margins may be determined from candidate values defined in the NR specification. Candidate values are selected to cover different measurement configurations (e.g., RS bandwidth (BW)) and to accommodate different implementations. For Tx TEGs and Rx TEGs, the candidates for NR Release 17 are 0 Tc, 2 Tc, 4 Tc, 6 Tc, 8 Tc, 12 Tc, 16 Te, 20 Tc, 24 Te, 32 Te, 40 Tc, 48 Tc, 56Tc, 64 Tc, 72 Tc, 80 Tc, but are not yet defined for RxTx TEGs. For each type of TEG, the UE/TRP chooses one of the values based on its implementation. In a measurement report, all Rx TEGs have the same timing error margin, and all RxTx TEGs have the same timing error margin. All Tx TEGs defined in the same time period have the same timing error margin. The timing error margin(s) is included in the measurement report or Tx TEG report. The timing error margin can be different for different measurement or Tx TEG report instances.

FIG. 11 shows tables illustrating group delay calibration margin candidates for UE Rx-Tx measurement accuracy with respect to RS bandwidth, according to aspects of the disclosure. In this example, table 1102 shows the group delay calibration margin candidates for FR1, while table 1104 shows the group delay calibration margin candidates for FR2. It will be recognized, based on the teachings of the disclosure, that the foregoing candidate values constitute non-limiting examples. Additional and/or different candidate values/bandwidths may be employed and standardized for the preconfigured group delay calibration margins.

Certain aspects of the disclosure recognize that a UE may not have the capability of measuring or transmitting an RS over a wide bandwidth. Some UEs, such as reduced capability (RedCap) devices, however, are expected to be able to tune to different frequencies in a band and tune to different sections of the RS bandwidth at different time occasions (e.g., slots). In this way, the UE may capture a larger aggregated bandwidth of the RS to provide more accurate positioning estimates. To this end, positioning sessions employing such devices may be based on “frequency hopping.” For example, a signal (e.g., a PRS) may be transmitted across the full bandwidth (e.g., 272 PRBs for PRS) in each time occasion (e.g., slot). A UE can then measure different portions (e.g., different symbols) of the PRS resource in different subsets of the 272 PRBs over the span of multiple slots. A subset of contiguous PRBs in the frequency domain is referred to as a “hop,” and the UE “stitches” together the measurement of the PRS resource in each subset of PRBs (i.e., each hop) to determine a final measurement of the PRS resource.

Where a UE supports frequency hopping, the measurement period (e.g., for an RSTD measurement) can be updated to account for the longer time needed to measure a nominal bandwidth. In addition, the expected/required positioning accuracy may need to be updated to account for accuracy loss due to realistic stitching and UE capabilities. There may also need to be overlapped hopping to enable estimation of the phase offset due to the switching.

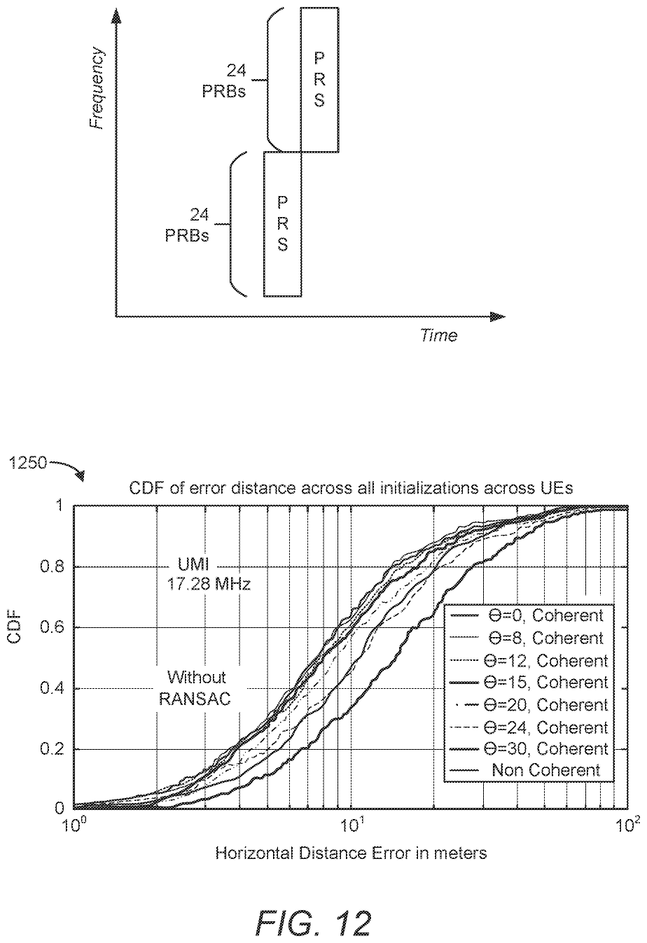

Although symbols transmitted in the same slot are assumed to be coherent (i.e., have phase coherency), the measurements of the different sections of bandwidth may not be coherent with each other due to the UE re-tuning its radio to receive the different hops. FIG. 12 illustrates an evaluation of phase offset for a two-hop scenario, according to aspects of the disclosure. Diagram 1200 illustrates two 24-PRB PRS hops in the frequency domain. Each PRS hop may span one or two symbols of the same slot in the time domain. Because the UE retunes its radio to measure the different hops, there is some phase offset between the two PRS hops.

Graph 1250 illustrates the cumulative distribution function (CDF) of the error distance across all initializations for an outdoor UE with an SCS of 30 kHz and without performing random sample consensus (RANSAC) outlier rejection. In the scenario shown in graph 1250, for each additional hop, a random sample is drawn from a uniform distribution of θ=2π·[−α, α], where θ is the phase and α is a range for graphing purposes, such as [−0.5, 0.5]. The phase offset is applied in the logged channel frequency response (CFR) of the hop. The two CFRs are concatenated on the same IFFT and then the ToA is estimated. As shown, a phase uncertainty of up to approximately eight degrees does not meaningfully affect positioning performance.

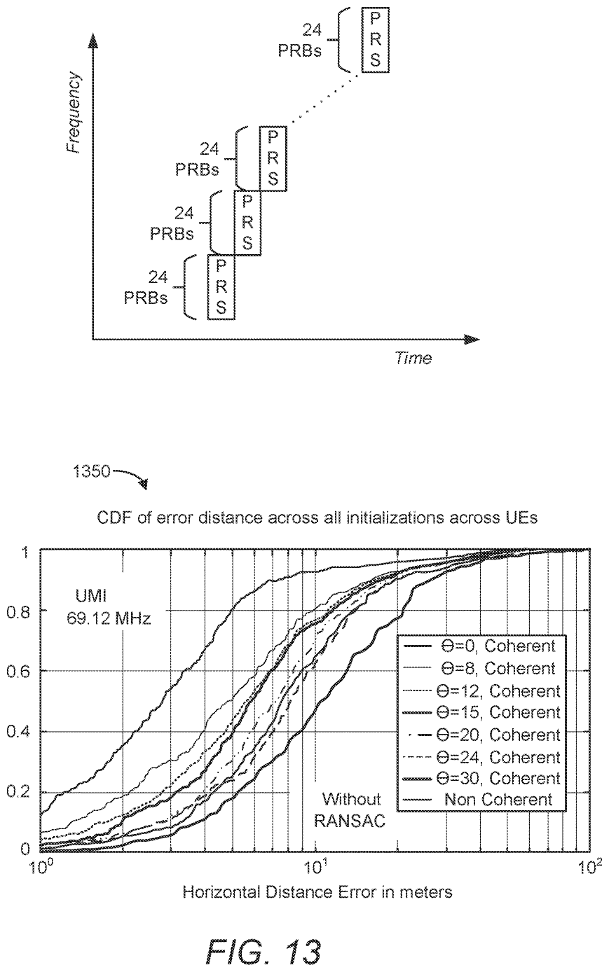

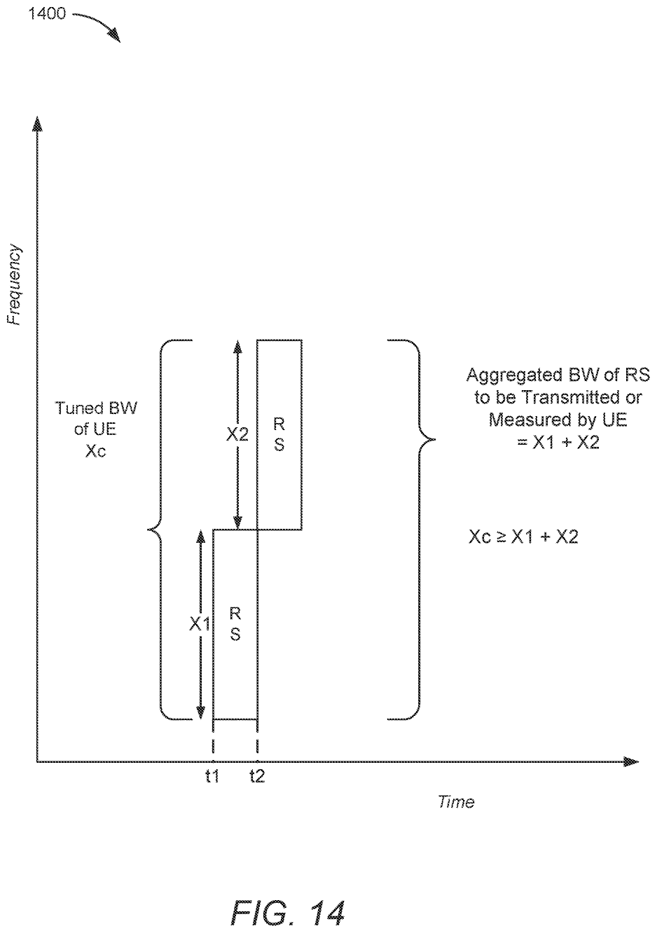

FIG. 13 illustrates an evaluation of phase offset for an eight-hop scenario, according to aspects of the disclosure, Diagram 1300 illustrates eight 24-PRB PRS hops in the frequency domain. Each PRS hop may span one or two symbols in the time domain. Because the UE retunes its radio to measure the different hops, there is some phase offset between the eight PRS hops. Graph 1350 illustrates the CDF of the error distance across all initializations across UEs with an SCS of 30 kHz.

In accordance with certain aspects of the disclosure, a UE may perform frequency hopping during transmission of UL-RS (e.g., SRS). In such instances, the UE may tune to different bandwidths to transmit the RS at different time occasions during the positioning session. The UL-RS may be transmitted with frequency hopping characteristics similar to those shown in diagram 1200 of FIG. 12 and in diagram 1300 of FIG. 13.

In accordance with certain aspects of the disclosure, the UE may also receive frequency-hopped RS (e.g., sidelink (SL) RS) from another UE. In such instances, the RS are transmitted by the SL UE over different bandwidths at different times and are likewise measured by the UE over the different bandwidths and different times. The SL-RS may be received with frequency hopping characteristics similar to those shown in diagram 1200 of FIG. 12 and in diagram 1300 of FIG. 13.

Certain aspects of the disclosure recognize that there are difficulties in determining the group delay margin that is to be used for a positioning session involving frequency hopping. Such difficulties arise since the UE may have limited bandwidth capabilities and need to re-tune to multiple frequency bandwidths to transmit or measure all of the RS over the frequency hops in certain scenarios. However, it may also be the case that a UE may have sufficient bandwidth capability so that re-tuning of the UE is unnecessary to transmit or receive the RS over the frequency hops.

In accordance with the various aspects of the disclosure, the group delay margin for a UE taking part in a positioning session involving frequency hopping may be based on whether the UE needs to be re-tuned to transmit or measure all of the RS over the frequency hops during the positioning session. In an aspect, an operation to determine an aggregated bandwidth corresponding to a total bandwidth of multiple reference signals (RS) transmitted based on frequency hopping the RS to different frequency ranges during a positioning session may be made. In an aspect, a tuned bandwidth of the UE for transmitting or receiving the RS may be determined. A first group delay margin from a set of preconfigured group delay margins (e.g., standardized values for group delay margins) is used as the group delay margin based on the tuned bandwidth being less than or equal to the aggregated bandwidth. In such instances, the first group delay margin may be based on a preconfigured group delay margin of the set of preconfigured group delay margins corresponding to the tuned bandwidth (e.g., the standardized group delay margin corresponding to a bandwidth range including the tuned bandwidth). If the aggregated bandwidth is greater than the tuned bandwidth, a second group delay margin is used as the group delay margin. In an aspect, the second group delay margin may be based on a sum of preconfigured group delay margins associated with bandwidths to which the UE is tuned to transmit or receive the RS over the aggregated bandwidth. Once the group delay margin has been determined, the multiple RS may be transmitted or received during the positioning session based on the first group delay margin or the second group delay margin.

FIG. 14 depicts a frequency hopping scenario 1400 that may be analyzed to determine a group delay margin for use in the corresponding positioning session, according to aspects of the disclosure. In this example, the RS are frequency hopped over two different frequency spans, X1 and X2, of equal bandwidths (e.g., 20 MHz each) at times t1 and t2, respectively. The UE has a tuned bandwidth Xc (e.g., bandwidth capability) that is sufficient to cover the aggregated bandwidth of the RS (X1+X2) (e.g., 40 MHz) without the need for re-tuning. As such, the group delay margin may be determined based on the group delay margin corresponding to the bandwidth Xi in the preconfigured (e.g., standardized) set of group delay margins. With reference to the preconfigured set of group delay margins set forth in table 1104 of FIG. 11, the tuned bandwidth of 40 MHz is greater than the 20 MHz bandwidth associated with group delay margin 76 Te, but less than the 50 MHz associated with group delay margin 32 Te. As such, the group delay margin used for the positioning session should be 76 Tc.

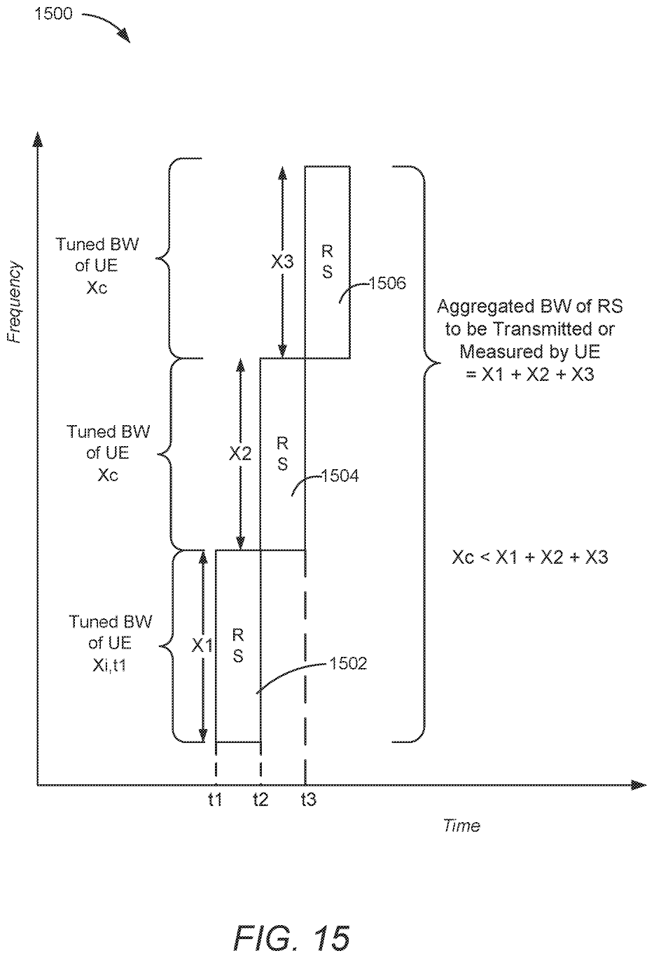

FIG. 15 depicts another frequency hopping scenario 1500 that may be analyzed to determine a group delay margin for use in the corresponding positioning session, according to aspects of the disclosure. In this example, the RS are frequency hopped over three different frequency spans X1, X2, and X3, covering three bandwidths of equal size (e.g., 20 MHz each) at times t1, t2, and t3, respectively. The UE only supports a tuned bandwidth Xc (e.g., 20 MHZ), which is insufficient to cover the aggregated bandwidth of the RS (X1+X2+X3)(e.g., 60 MHz) without the need for re-tuning. As such, the UE is tuned to 1) the frequency span X1 with a bandwidth of Xc at time t1 to transmit or receive the first RS 1502, 2) the frequency span X2 with a bandwidth Xc at time t2 to transmit or receive the second RS 1504, and 3) the frequency span X3 with a bandwidth Xc at time t3 to transmit or receive the third RS 1506. Since the UE has been tuned multiple times (the first tuning at t1 followed by subsequent re-tunings at t2 and t3), the group delay margin does not correspond directly to the tuned bandwidth Xc as it was in the frequency hopping scenario 1400 of FIG. 14. Rather, because separate Rx chains (for received RS) or separate Tx chains (for RS transmissions) have been used by the UE, the group delay margin errors are independent between each measurement of each RS 1502, 1504, and 1506.

In accordance with certain aspects of the disclosure, the group delay margin for frequency hopping scenario 1500 may be determined as a sum of the group delay margins GD1+GD2+GD3, where GDi corresponds to the group delay margin for measuring the bandwidth of frequency span Xi. In this example, the bandwidth used to measure each frequency span Xi is 20 MHz. With reference to the preconfigured set of group delay margins set forth in table 1104 of FIG. 11, the tuned bandwidth of 20 MHz is associated with a group delay margin of 76 Tc. As such, the group delay margin used for the positioning session should be GD1+GD2+GD3=228 Tc. It will be recognized, based on the teachings of the disclosure, that GD1, GD2, and GD3 may have different values where different bandwidths are associated with transmitting or receiving the RS of the different frequency hops.

In accordance with certain aspects of the disclosure, the foregoing determination of the group delay margin may be simplified. If the UE performs N hops, then the group delay margin will correspond to N*max(GDi), wherein GDi is the preconfigured group delay margin for the bandwidth transmitted or measured in the ith hop.

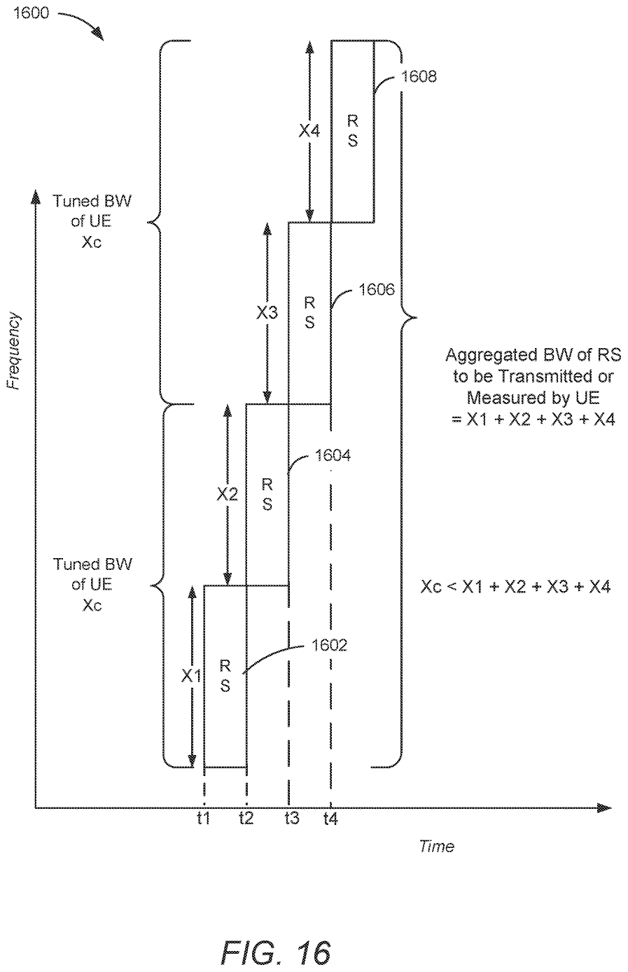

FIG. 16 depicts another frequency hopping scenario 1600 that may be analyzed to determine a group delay margin for use in the corresponding positioning session, according to aspects of the disclosure. In this example, the RS are frequency hopped over four different frequency spans X1, X2, X3, and X4 covering four bandwidths of equal size (e.g., 50 MHz each) at times t1, t2, t3, and t4, respectively. The UE only supports a tuned bandwidth Xc (e.g., 100 MHz) that is insufficient to cover the aggregated bandwidth of the RS (X1+X2+X3+X4)(e.g., 200 MHz) without the need for re-tuning. As such, the UE is tuned first to the frequency span X1 and X2 with a bandwidth of Xc at time t1 to transmit or receive the first RS 1602 and the second RS 1604. Next, the UE is tuned to the frequency span X3 and X4 with a bandwidth of Xc at time t3 to transmit or receive the third RS 1606 and the fourth RS 1608. Since the UE has been tuned multiple times (the first tuning at t1 followed by subsequent re-tuning at t3), the group delay margin does not correspond directly to the tuned bandwidth Xc as was the case in the frequency hopping scenario 1400 of FIG. 14. Rather, because separate Rx chains (for received RS) or separate Tx chains (for RS transmissions) have been used by the UE, the group delay margin errors are independent between each measurement of each the first set of RS (RS 1602 and 1604) and the second set of RS (RS 1606 and 1608).

In accordance with certain aspects of the disclosure, the group delay margin for frequency hopping scenario 1600 may be determined as a sum of the group delay margins for each tuning of the UE with bandwidth Xc to measure the RS over the aggregated bandwidth of all of the RS in the frequency-hopping positioning session. In this example, the bandwidth used by the UE to transmit or measure the frequency span covered by X1 and X2 (e.g., 100 MHz) is Xc (100 MHz). Similarly, the bandwidth used by the UE to transmit or measure the frequency span covered by X3 and X4 (e.g., 100 MHz) is likewise Xc (e.g., 100 MHz). With reference to the preconfigured set of group delay margins set forth in table 1104 of FIG. 11, the tuned bandwidth of 100 MHz is associated with a group delay margin 24 Tc. Since the UE was tuned twice with a bandwidth of Xc=100 MHZ, the group delay margin used for the positioning session should be 48 Tc (e.g., 2×24 Tc).

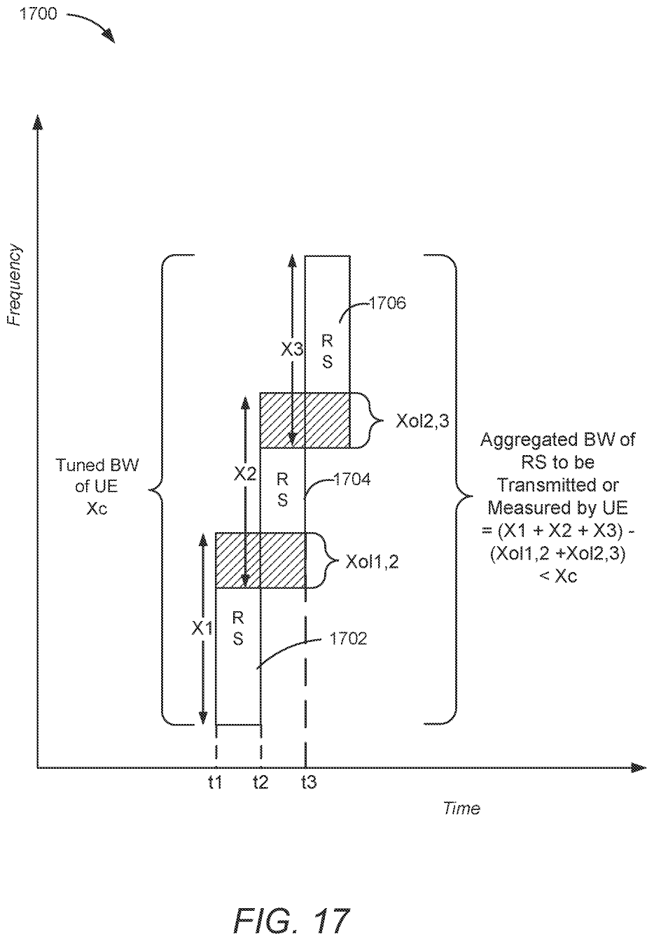

FIG. 17 depicts another frequency hopping scenario 1700 that may be analyzed to determine a group delay margin for use in the corresponding positioning session, according to aspects of the disclosure. In this example, the RS 1702, 1704, and 1706 are frequency hopped over three different frequency spans X1, X2, and X3 of equal bandwidths (e.g., 20 MHz each) at times t1, t2, and t3, respectively. However, in this scenario the span of X1 overlaps with the frequency span X2, and the frequency span X2 overlaps with the frequency span X3. As such, the aggregated bandwidth of the RS is not merely the sum of the frequency spans X1+X2+X3. Rather, the aggregated bandwidth should take into consideration the bandwidth of the overlapping frequency ranges labeled Xol1,2 and Xol2,3. As such, the aggregated bandwidth may be determined as the sum of the frequency spans X1+X2+X3 reduced by the total bandwidth of the overlapping frequency ranges Xol1,2 and Xol2,3. Assuming, for example, that the total bandwidth of the overlapping frequency ranges Xol1,2 and Xol2,3 is 10 MHz, then the aggregated bandwidth is 50 MHz ((20 MHz+20 MHz+20 MHz)−10 MHz).

In this example, the UE has a tuned bandwidth Xc (e.g., bandwidth capability) of 50 MHz that is sufficient to cover the aggregated bandwidth (e.g., 50 MHz) without the need for re-tuning. As such, the group delay margin may be determined based on the group delay margin corresponding to the bandwidth Xc in the preconfigured (e.g., standardized) set of group delay margins. With reference to the preconfigured set of group delay margins set forth in table 1104 of FIG. 11, the tuned bandwidth of 50 MHz is associated with a group delay margin of 32 Te, which is the group delay margin to be used for the positioning session.

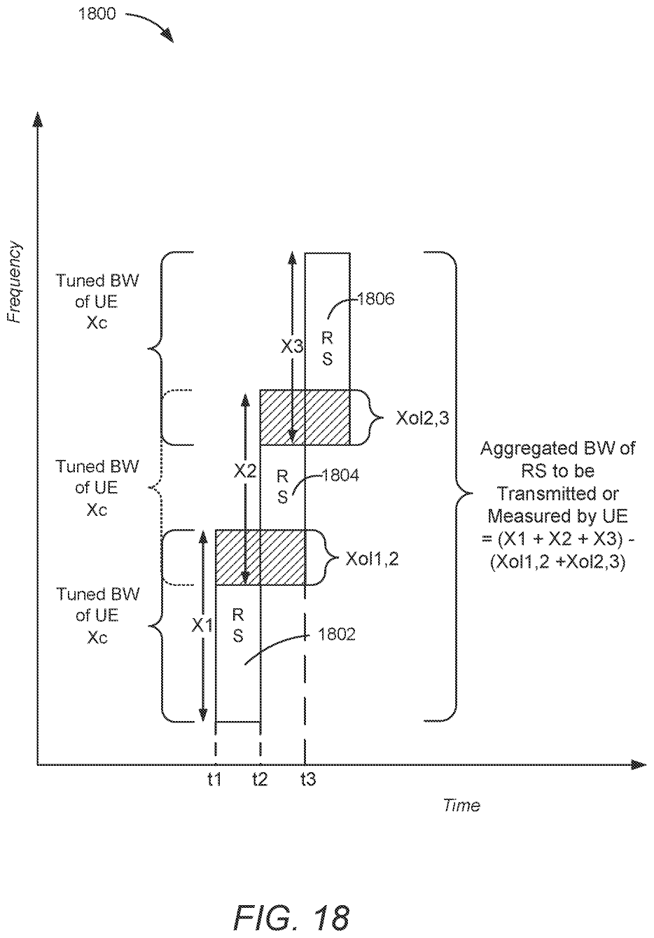

FIG. 18 depicts another frequency hopping scenario 1800 that may be analyzed to determine a group delay margin for use in the corresponding positioning session, according to aspects of the disclosure. In this example, the RS are frequency hopped over three different frequency spans X1, X2, and X3 of equal bandwidths (e.g., 20 MHz each) at times t1, t2, and t3, respectively. However, in this scenario the span of X1 overlaps with the frequency span X2, and the frequency span X2 overlaps with the frequency span X3. As such, the aggregated bandwidth of the RS is not merely the sum of the frequency spans X1+X2+X3. Rather, the aggregated bandwidth should take into consideration the bandwidth of the overlapping frequency ranges labeled Xol1,2 and Xol2,3. As such, the aggregated bandwidth may be determined as the sum of the frequency spans X1+X2+X3 reduced by the total bandwidth of the overlapping frequency ranges Xol1,2 and Xol2,3. Assuming, for example, that the total bandwidth of the overlapping frequency ranges Xol1,2 and Xol2,3 is 10 MHz, then the aggregated bandwidth is 50 MHz ((20 MHz+20 MHz+20 MHz)−10 MHz).

The UE in this example only supports a tuned bandwidth Xc (e.g., 20 MHZ), which is insufficient to cover the aggregated bandwidth of the RS (50 MHz) without the need for re-tuning. As such, the UE is tuned to 1) the frequency span X1 with a bandwidth of Xc at time t1 to transmit or receive the first RS 1802, 2) the frequency span X2 with the bandwidth of Xc at time t2 to transmit or receive the second RS 1804, and 3) the frequency span X3 with the bandwidth of Xc at time t3 to transmit or receive the third RS 1806. Since the UE has been tuned multiple times (the first tuning at t1 followed by subsequent re-tuning at t3), the group delay margin does not correspond directly to the tuned bandwidth Xc as was the case in the frequency hopping scenario 1700 of FIG. 17. Rather, because separate Rx chains (for received RS) or separate Tx chains (for RS transmissions) have been used by the UE, the group delay margin errors are independent between each RS transmission or measurement.

In accordance with certain aspects of the disclosure, the group delay margin for frequency hopping scenario 1800 may be determined as a sum of the group delay margins GD1+GD2+GD3, where GDi corresponds to the group delay margin for measuring the bandwidth of frequency span Xi. In this example, the bandwidth used to measure each frequency span Xi is Xc (e.g., 20 MHz). With reference to the preconfigured set of group delay margins set forth in table 1104 of FIG. 11, the tuned bandwidth of 20 MHz is associated with a group delay margin of 76 Te. As such, the group delay margin used for the positioning session should be GD1+GD2+GD3=228 Te. It will be recognized, based on the teachings of the disclosure, that GD1, GD2, and GD3 may have different values where different bandwidths are associated with transmitting or receiving the RS of the different frequency hops. Again, this determination may be simplified in certain scenarios. If the UE performs N hops, then the group delay margin will correspond to N*max(GDi), wherein GDi is the preconfigured group delay margin for the bandwidth transmitted or measured (e.g., Tc) in the ith hop.

The set of predetermined group delay margins for the frequency hopping positioning sessions may be simplified in various manners. In accordance with an aspect of the disclosure, the set of predetermined group delay margins only includes group delay margins specified for a UE performing equal bandwidth measurements in each frequency hop (e.g., 20 +20 MHZ). In accordance with this aspect, no group delay margin requirements are specified unless each frequency hop has the same BW. For example, group delay margin requirements may be specified for a 20 MHz but not specified for 20+40 MHz frequency hops. Additionally, or in the alterative, the set of predetermined group delay margins may be specified for the peak bandwidth (e.g., largest tuned bandwidth Xc) that the UE supports. For example, if the UE supports a maximum bandwidth of 20 MHz, then there will be group delay margins specified for the 20+20 MHz scenario, but there will not be group delay margins specified for 5+5 MHz scenarios. In this regard, if a UE's maximum bandwidth is 20 MHz, the group delay margin will be specified for frequency hops of 20 Mhz each, and not for a smaller bandwidth. As such, if the UE is eventually configured to perform 5 MHz frequency hops, then there will not be a separate group delay margin specified for the 5 MHz frequency hops.

In accordance with certain aspects of the disclosure, the UE may have the capability of measuring its own group delay margins (e. g, determine an actual group delay margin), This capability may be signaled by the UE to a network node and used to report measured group delays that are less than the group delays determined from the preconfigured set of group delays. In an aspect, the UE may report a reduced group delay margin based on the actual group delay margin at the UE being less than the determined group delay margin.

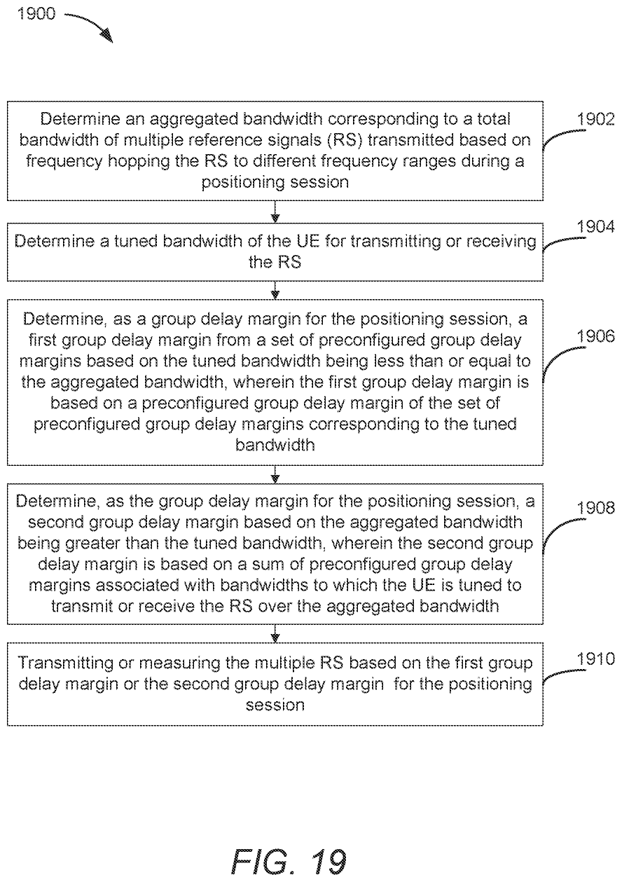

As noted, the foregoing group delay determinations are applicable to both the DL-RS and UL-RS frequency hopping scenarios. For UE Rx-Tx, if the UE performs SRS frequency hopping, the group delay margin for the hopped measurement may be derived by using a legacy group delay margin table and using the “SRS BW” as the “aggregated SRS BW” that has been hopped based on the same concept associated with the PRS aggregation discussed herein. In another aspect, the group delay margin for the hopped measurement may be derived by using the legacy group delay margin table and using as a group delay margin that is N times the group delay margin that corresponds to the “SRS BW” =“SRS BW of each hop,” or “SRS BW” =“minimum SRS BW across all hops.” FIG. 19 illustrates an example method 1900 of wireless communication that may be performed by a UE, according to aspects of the disclosure. At operation 1902, the UE determines an aggregated bandwidth corresponding to a total bandwidth of multiple reference signals (RS) transmitted based on frequency hopping the RS to different frequency ranges during a positioning session. In an aspect, operation 1902 may be performed by the one or more WWAN transceivers 310, the one or more processors 332, memory 340, and/or positioning component 342, any or all of which may be considered means for performing this operation.

At operation 1904, the UE determines a tuned bandwidth of the UE for transmitting or receiving the RS. In an aspect, operation 1904 may be performed by the one or more WWAN transceivers 310, the one or more processors 332, memory 340, and/or positioning component 342, any or all of which may be considered means for performing this operation.

At operation 1906, the UE determines, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth. In an aspect, operation 1906 may be performed by the one or more WWAN transceivers 310, the one or more processors 332, memory 340, and/or positioning component 342, any or all of which may be considered means for performing this operation.

At operation 1908, the UE determines, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth. In an aspect, operation 1908 may be performed by the one or more WWAN transceivers 310, the one or more processors 332, memory 340, and/or positioning component 342, any or all of which may be considered means for performing this operation.

At operation 1910, the UE transmits or measures the multiple RS based on the first group delay margin or the second group delay margin for the positioning session. In an aspect, operation 1910 may be performed by the one or more WWAN transceivers 310, the one or more processors 332, memory 340, and/or positioning component 342, any or all of which may be considered means for performing this operation.

As will be appreciated, a technical advantage of the method 1900 is that it may be used to determine the group delay margin of a UE that is used in a frequency hopping positioning session. The method is particularly suited for UEs having limited bandwidth capabilities.

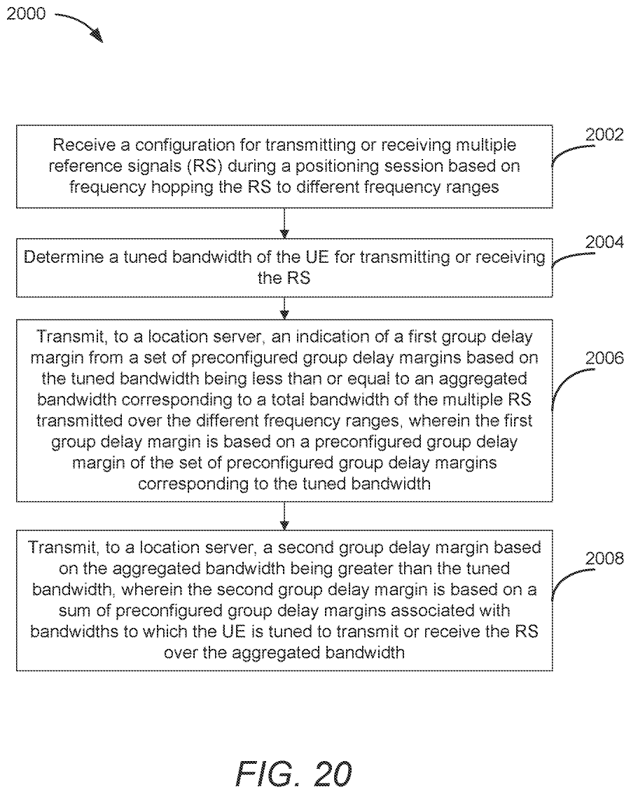

FIG. 20 illustrates an example method 2000 of wireless communication that may be performed by a UE, according to aspects of the disclosure. At operation 2002, the UE receives a configuration for transmitting or receiving multiple reference signals (RS) during a positioning session based on frequency hopping the RS to different frequency ranges. In an aspect, operation 2002 may be performed by the one or more WWAN transceivers 310, the one or more processors 332, memory 340, and/or positioning component 342, any or all of which may be considered means for performing this operation.

At operation 2004, the UE determines a tuned bandwidth of the UE for transmitting or receiving the RS. In an aspect, operation 2004 may be performed by the one or more WWAN transceivers 310, the one or more processors 332, memory 340, and/or positioning component 342, any or all of which may be considered means for performing this operation.

At operation 2006, the UE transmits, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth. In an aspect, operation 2006 may be performed by the one or more WWAN transceivers 310, the one or more processors 332, memory 340, and/or positioning component 342, any or all of which may be considered means for performing this operation.

At operation 2008, the UE transmits, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth. In an aspect, operation 2008 may be performed by the one or more WWAN transceivers 310, the one or more processors 332, memory 340, and/or positioning component 342, any or all of which may be considered means for performing this operation.

As will be appreciated, a technical advantage of the method 2000 is that it allows the UE to determine and report the group delay margin that is used by the UE in a frequency hopping positioning session. The method is particularly suited for UEs having limited bandwidth capabilities.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: determining an aggregated bandwidth corresponding to a total bandwidth of multiple reference signals (RS) transmitted based on frequency hopping the RS to different frequency ranges during a positioning session; determining a tuned bandwidth of the UE for transmitting or receiving the RS; determining, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth; determining, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and transmitting or measuring the multiple RS based on the first group delay margin or the second group delay margine for the positioning session.

Clause 2. The method of clause 1, wherein: each group delay margin GD(i) of the set of preconfigured group delay margins is associated with a corresponding RS bandwidth range BW(i).

Clause 3. The method of clause 2, wherein: the first group delay margin is a preconfigured group delay margin associated with a bandwidth range corresponding to the tuned bandwidth.

Clause 4. The method of any of clauses 2 to 3, wherein: the second group delay margin is determined as a multiple N of a group delay margin GD(max) associated with a bandwidth range BW(max) corresponding to a maximum bandwidth to which the UE is tuned to receive the RS during the positioning session.

Clause 5. The method of any of clauses 1 to 4, wherein: the set of preconfigured group delay margins is specified for a peak bandwidth supported by the UE.

Clause 6. The method of any of clauses 1 to 5, wherein: the set of preconfigured group delay margins includes one or more preconfigured group delay margins each corresponding to a preconfigured bandwidth range, wherein the preconfigured bandwidth range correspond to a bandwidth of the RS at each frequency hop.

Clause 7. The method of any of clauses 1 to 6, wherein: the UE is configured to be tuned multiple times to receive the RS during the positioning session.

Clause 8. The method of any of clauses 1 to 7, wherein: the second group delay margin is based on a multiple N of the preconfigured group delay margin associated with the tuned bandwidth, wherein N corresponds to a number of frequency hops of the RS during the positioning session.

Clause 9. The method of any of clauses 1 to 8, wherein: each RS transmission has a common bandwidth when transmitted over each frequency range of the different frequency ranges; and the aggregated bandwidth is based on a multiple M of the common bandwidth, wherein M is a number of RS transmissions for the positioning session.

Clause 10. The method of any of clauses 1 to 9, wherein: one or more frequency hops of the RS results in a bandwidth overlap between two or more RS transmissions; and the aggregated bandwidth is based on a sum of the bandwidths of the RS transmissions over the different frequency ranges which is reduced by a bandwidth amount corresponding to a total bandwidth overlap between the two or more RS transmissions.

Clause 11. The method of any of clauses 1 to 10, wherein: each RS transmission has a common bandwidth; one or more frequency hops of the RS results in a bandwidth overlap between two or more RS transmissions; and the aggregated bandwidth is based on a multiple M of the common bandwidth reduced by a bandwidth amount corresponding to a total bandwidth overlap between the two or more RS transmissions, wherein M is a number of RS frequency hops for the positioning session.

Clause 12. The method of any of clauses 1 to 11, further comprising: reporting, by the UE, the group delay margin to a location server.

Clause 13. The method of any of clauses 1 to 12, further comprising: reporting, by the UE, a reduced group delay margin based on an actual group delay margin at the UE being less than the first group delay margin or the second group delay margin.

Clause 14. The method of any of clauses 1 to 13, further comprising: reporting, by the UE, an indication that the second group delay margin exceeds a maximum group delay margin tolerance for the positioning session.

Clause 15. A method of wireless communication performed by a user equipment (UE), comprising: receiving a configuration for transmitting or receiving multiple reference signals (RS) during a positioning session based on frequency hopping the RS to different frequency ranges; determining a tuned bandwidth of the UE for transmitting or receiving the RS; transmitting, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and transmitting, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

Clause 16. The method of clause 15, wherein: each group delay margin GD(i) of the set of preconfigured group delay margins is associated with a corresponding bandwidth range BW(i).

Clause 17. The method of clause 16, wherein: the first group delay margin is a preconfigured group delay margin associated with a bandwidth range corresponding to the tuned bandwidth.

Clause 18. The method of any of clauses 16 to 17, wherein: the second group delay margin is determined as a multiple N of a group delay margin GD(max) associated with a bandwidth range BW(max) corresponding to a maximum bandwidth to which the UE is tuned to receive the RS during the positioning session.

Clause 19. The method of any of clauses 15 to 18, wherein: the multiple reference signals are uplink sounding reference signals (SRS) transmitted by the UE.

Clause 20. The method of any of clauses 15 to 18, wherein: the multiple reference signals are downlink positioning reference signals (PRS) measured at the UE.

Clause 21. The method of any of clauses 15 to 20, wherein: the second group delay margin is based on a multiple N of the preconfigured group delay margin associated with the tuned bandwidth, wherein N corresponds to a number of frequency hops of the RS during the positioning session.

Clause 22. The method of any of clauses 15 to 21, wherein: each RS transmission has a common bandwidth when transmitted over each frequency range of the different frequency ranges; and the aggregated bandwidth is based on a multiple M of the common bandwidth, wherein M is a number of RS transmissions for the positioning session.

Clause 23. The method of any of clauses 15 to 22, wherein: one or more of frequency hops of the RS results in a bandwidth overlap between two or more RS transmissions; and the aggregated bandwidth is based on a sum of the bandwidths of the RS transmissions over the different frequency ranges which is reduced by a bandwidth amount corresponding to a total bandwidth overlap between the two or more RS transmissions.

Clause 24. The method of any of clauses 15 to 23, wherein: each RS transmission has a common bandwidth; and one or more frequency hops of the RS results in a bandwidth overlap between two or more RS transmissions; and the aggregated bandwidth is based on a multiple M of the common bandwidth reduced by a bandwidth amount corresponding to a total bandwidth overlap between the two or more RS transmissions, wherein M is a number of RS frequency hops for the positioning session.

Clause 25. A user equipment (UE), comprising: a memory; at least one transceiver; and at least one processor communicatively coupled to the memory and the at least one transceiver, the at least one processor configured to: determine an aggregated bandwidth corresponding to a total bandwidth of multiple reference signals (RS) transmitted based on frequency hopping the RS to different frequency ranges during a positioning session; determine a tuned bandwidth of the UE for transmitting or receiving the RS; determine, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth; determine, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and transmit, via the at least one transceiver, or measuring the multiple RS based on the first group delay margin or the second group delay margin for the positioning session,

Clause 26. The UE of clause 25, wherein: each group delay margin GD(i) of the set of preconfigured group delay margins is associated with a corresponding RS bandwidth range BW(i).

Clause 27. The UE of clause 26, wherein: the first group delay margin is a preconfigured group delay margin associated with a bandwidth range corresponding to the tuned bandwidth.

Clause 28. The UE of any of clauses 26 to 27, wherein: the second group delay margin is determined as a multiple N of a group delay margin GD(max) associated with a bandwidth range BW(max) corresponding to a maximum bandwidth to which the UE is tuned to receive the RS during the positioning session,

Clause 29. The UE of any of clauses 25 to 28, wherein: the set of preconfigured group delay margins is specified for a peak bandwidth supported by the UE.

Clause 30. The UE of any of clauses 25 to 29, wherein: the set of preconfigured group delay margins includes one or more preconfigured group delay margins each corresponding to a preconfigured bandwidth range, wherein the preconfigured bandwidth range correspond to a bandwidth of the RS at each frequency hop.

Clause 31. The UE of any of clauses 25 to 30, wherein: the UE is configured to be tuned multiple times to receive the RS during the positioning session.

Clause 32. The UE of any of clauses 25 to 31, wherein: the second group delay margin is based on a multiple N of the preconfigured group delay margin associated with the tuned bandwidth, wherein N corresponds to a number of frequency hops of the RS during the positioning session.

Clause 33. The UE of any of clauses 25 to 32, wherein: each RS transmission has a common bandwidth when transmitted over each frequency range of the different frequency ranges; and the aggregated bandwidth is based on a multiple M of the common bandwidth, wherein M is a number of RS transmissions for the positioning session.

Clause 34. The UE of any of clauses 25 to 33, wherein: one or more frequency hops of the RS results in a bandwidth overlap between two or more RS transmissions; and the aggregated bandwidth is based on a sum of the bandwidths of the RS transmissions over the different frequency ranges which is reduced by a bandwidth amount corresponding to a total bandwidth overlap between the two or more RS transmissions.

Clause 35. The UE of any of clauses 25 to 34, wherein: each RS transmission has a common bandwidth; one or more frequency hops of the RS results in a bandwidth overlap between two or more RS transmissions; and the aggregated bandwidth is based on a multiple M of the common bandwidth reduced by a bandwidth amount corresponding to a total bandwidth overlap between the two or more RS transmissions, wherein M is a number of RS frequency hops for the positioning session.

Clause 36. The UE of any of clauses 25 to 35, wherein the at least one processor is further configured to: report, via the at least one transceiver, the group delay margin to a location server.

Clause 37. The UE of any of clauses 25 to 36, wherein the at least one processor is further configured to: report, via the at least one transceiver, a reduced group delay margin based on an actual group delay margin at the UE being less than the first group delay margin or the second group delay margin.

Clause 38. The UE of any of clauses 25 to 37, wherein the at least one processor is further configured to; report, via the at least one transceiver, an indication that the second group delay margin exceeds a maximum group delay margin tolerance for the positioning session.

Clause 39. A user equipment (UE), comprising: a memory; at least one transceiver; and at least one processor communicatively coupled to the memory and the at least one transceiver, the at least one processor configured to: receive, via the at least one transceiver, a configuration for transmitting or receiving multiple reference signals (RS) during a positioning session based on frequency hopping the RS to different frequency ranges; determine a tuned bandwidth of the UE for transmitting or receiving the RS; transmit, via the at least one transceiver, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and transmit, via the at least one transceiver, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

Clause 40. The UE of clause 39, wherein: each group delay margin GD(i) of the set of preconfigured group delay margins is associated with a corresponding bandwidth range BW(i).

Clause 41. The UE of clause 40, wherein: the first group delay margin is a preconfigured group delay margin associated with a bandwidth range corresponding to the tuned bandwidth.

Clause 42. The UE of any of clauses 40 to 41, wherein: the second group delay margin is determined as a multiple N of a group delay margin GD(max) associated with a bandwidth range BW(max) corresponding to a maximum bandwidth to which the UE is tuned to receive the RS during the positioning session,

Clause 43. The UE of any of clauses 39 to 42, wherein: the multiple reference signals are uplink sounding reference signals (SRS) transmitted by the UE.

Clause 44. The UE of any of clauses 39 to 42, wherein: the multiple reference signals are downlink positioning reference signals (PRS) measured at the UE.

Clause 45. The UE of any of clauses 39 to 44, wherein: the second group delay margin is based on a multiple N of the preconfigured group delay margin associated with the tuned bandwidth, wherein N corresponds to a number of frequency hops of the RS during the positioning session.

Clause 46. The UE of any of clauses 39 to 45, wherein: each RS transmission has a common bandwidth when transmitted over each frequency range of the different frequency ranges; and the aggregated bandwidth is based on a multiple M of the common bandwidth, wherein M is a number of RS transmissions for the positioning session.

Clause 47. The UE of any of clauses 39 to 46, wherein: one or more of frequency hops of the RS results in a bandwidth overlap between two or more RS transmissions; and the aggregated bandwidth is based on a sum of the bandwidths of the RS transmissions over the different frequency ranges which is reduced by a bandwidth amount corresponding to a total bandwidth overlap between the two or more RS transmissions.

Clause 48. The UE of any of clauses 39 to 47, wherein: each RS transmission has a common bandwidth; and one or more frequency hops of the RS results in a bandwidth overlap between two or more RS transmissions; and the aggregated bandwidth is based on a multiple M of the common bandwidth reduced by a bandwidth amount corresponding to a total bandwidth overlap between the two or more RS transmissions, wherein M is a number of RS frequency hops for the positioning session.

Clause 49. A user equipment (UE), comprising: means for determining an aggregated bandwidth corresponding to a total bandwidth of multiple reference signals (RS) transmitted based on frequency hopping the RS to different frequency ranges during a positioning session; means for determining a tuned bandwidth of the UE for transmitting or receiving the RS; means for determining, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth; means for determining, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and means for transmitting or measuring the multiple RS based on the first group delay margin or the second group delay margin for the positioning session.

Clause 50. The UE of clause 49, wherein: each group delay margin GD(i) of the set of preconfigured group delay margins is associated with a corresponding RS bandwidth range BW(i).

Clause 51. The UE of clause 50, wherein: the first group delay margin is a preconfigured group delay margin associated with a bandwidth range corresponding to the tuned bandwidth.

Clause 52. The UE of any of clauses 50 to 51, wherein: the second group delay margin is determined as a multiple N of a group delay margin GD(max) associated with a bandwidth range BW(max) corresponding to a maximum bandwidth to which the UE is tuned to receive the RS during the positioning session.

Clause 53. The UE of any of clauses 49 to 52, wherein: the set of preconfigured group delay margins is specified for a peak bandwidth supported by the UE.

Clause 54. The UE of any of clauses 49 to 53, wherein: the set of preconfigured group delay margins includes one or more preconfigured group delay margins each corresponding to a preconfigured bandwidth range, wherein the preconfigured bandwidth range correspond to a bandwidth of the RS at each frequency hop.

Clause 55. The UE of any of clauses 49 to 54, wherein: the UE is configured to be tuned multiple times to receive the RS during the positioning session.

Clause 56. The UE of any of clauses 49 to 55, wherein; the second group delay margin is based on a multiple N of the preconfigured group delay margin associated with the tuned bandwidth, wherein N corresponds to a number of frequency hops of the RS during the positioning session.

Clause 57. The UE of any of clauses 49 to 56, wherein: each RS transmission has a common bandwidth when transmitted over each frequency range of the different frequency ranges; and the aggregated bandwidth is based on a multiple M of the common bandwidth, wherein M is a number of RS transmissions for the positioning session.

Clause 58. The UE of any of clauses 49 to 57, wherein: one or more frequency hops of the RS results in a bandwidth overlap between two or more RS transmissions; and the aggregated bandwidth is based on a sum of the bandwidths of the RS transmissions over the different frequency ranges which is reduced by a bandwidth amount corresponding to a total bandwidth overlap between the two or more RS transmissions.

Clause 59. The UE of any of clauses 49 to 58, wherein: each RS transmission has a common bandwidth; one or more frequency hops of the RS results in a bandwidth overlap between two or more RS transmissions; and the aggregated bandwidth is based on a multiple M of the common bandwidth reduced by a bandwidth amount corresponding to a total bandwidth overlap between the two or more RS transmissions, wherein M is a number of RS frequency hops for the positioning session.

Clause 60. The UE of any of clauses 49 to 59, further comprising: means for reporting the group delay margin to a location server.

Clause 61. The UE of any of clauses 49 to 60, further comprising: means for reporting a reduced group delay margin based on an actual group delay margin at the UE being less than the first group delay margin or the second group delay margin.

Clause 62. The UE of any of clauses 49 to 61, further comprising: means for reporting an indication that the second group delay margin exceeds a maximum group delay margin tolerance for the positioning session.

Clause 63. A user equipment (UE), comprising: means for receiving a configuration for transmitting or receiving multiple reference signals (RS) during a positioning session based on frequency hopping the RS to different frequency ranges; means for determining a tuned bandwidth of the UE for transmitting or receiving the RS; means for transmitting, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and means for transmitting, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

Clause 64. The UE of clause 63, wherein: each group delay margin GD(i) of the set of preconfigured group delay margins is associated with a corresponding bandwidth range BW(i).

Clause 65. The UE of clause 64, wherein: the first group delay margin is a preconfigured group delay margin associated with a bandwidth range corresponding to the tuned bandwidth.

Clause 66. The UE of any of clauses 64 to 65, wherein; the second group delay margin is determined as a multiple N of a group delay margin GD(max) associated with a bandwidth range BW(max) corresponding to a maximum bandwidth to which the UE is tuned to receive the RS during the positioning session.

Clause 67. The UE of any of clauses 63 to 66, wherein: the multiple reference signals are uplink sounding reference signals (SRS) transmitted by the UE.

Clause 68. The UE of any of clauses 63 to 66, wherein: the multiple reference signals are downlink positioning reference signals (PRS) measured at the UE.

Clause 69. The UE of any of clauses 63 to 68, wherein: the second group delay margin is based on a multiple N of the preconfigured group delay margin associated with the tuned bandwidth, wherein N corresponds to a number of frequency hops of the RS during the positioning session.

Clause 70. The UE of any of clauses 63 to 69, wherein: each RS transmission has a common bandwidth when transmitted over each frequency range of the different frequency ranges; and the aggregated bandwidth is based on a multiple M of the common bandwidth, wherein M is a number of RS transmissions for the positioning session.

Clause 71. The UE of any of clauses 63 to 70, wherein: one or more of frequency hops of the RS results in a bandwidth overlap between two or more RS transmissions; and the aggregated bandwidth is based on a sum of the bandwidths of the RS transmissions over the different frequency ranges which is reduced by a bandwidth amount corresponding to a total bandwidth overlap between the two or more RS transmissions.

Clause 72. The UE of any of clauses 63 to 71, wherein: each RS transmission has a common bandwidth; and one or more frequency hops of the RS results in a bandwidth overlap between two or more RS transmissions; and the aggregated bandwidth is based on a multiple M of the common bandwidth reduced by a bandwidth amount corresponding to a total bandwidth overlap between the two or more RS transmissions, wherein M is a number of RS frequency hops for the positioning session.

Clause 73. A non-transitory computer-readable medium storing computer-executable instructions that, when executed by a user equipment (UE), cause the UE to: determine an aggregated bandwidth corresponding to a total bandwidth of multiple reference signals (RS) transmitted based on frequency hopping the RS to different frequency ranges during a positioning session; determine a tuned bandwidth of the UE for transmitting or receiving the RS; determine, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth; determine, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and transmit or measuring the multiple RS based on the first group delay margin or the second group delay margin for the positioning session.

Clause 74. The non-transitory computer-readable medium of clause 73, wherein: each group delay margin GD(i) of the set of preconfigured group delay margins is associated with a corresponding RS bandwidth range BW(i).

Clause 75. The non-transitory computer-readable medium of clause 74, wherein: the first group delay margin is a preconfigured group delay margin associated with a bandwidth range corresponding to the tuned bandwidth.

Clause 76. The non-transitory computer-readable medium of any of clauses 74 to 75, wherein: the second group delay margin is determined as a multiple N of a group delay margin GD(max) associated with a bandwidth range BW(max) corresponding to a maximum bandwidth to which the UE is tuned to receive the RS during the positioning session.

Clause 77. The non-transitory computer-readable medium of any of clauses 73 to 76, wherein: the set of preconfigured group delay margins is specified for a peak bandwidth supported by the UE.

Clause 78. The non-transitory computer-readable medium of any of clauses 73 to 77, wherein: the set of preconfigured group delay margins includes one or more preconfigured group delay margins each corresponding to a preconfigured bandwidth range, wherein the preconfigured bandwidth range correspond to a bandwidth of the RS at each frequency hop.

Clause 79. The non-transitory computer-readable medium of any of clauses 73 to 78, wherein: the UE is configured to be tuned multiple times to receive the RS during the positioning session.

Clause 80. The non-transitory computer-readable medium of any of clauses 73 to 79, wherein: the second group delay margin is based on a multiple N of the preconfigured group delay margin associated with the tuned bandwidth, wherein N corresponds to a number of frequency hops of the RS during the positioning session.

Clause 81. The non-transitory computer-readable medium of any of clauses 73 to 80, wherein: each RS transmission has a common bandwidth when transmitted over each frequency range of the different frequency ranges; and the aggregated bandwidth is based on a multiple M of the common bandwidth, wherein M is a number of RS transmissions for the positioning session.

Clause 82. The non-transitory computer-readable medium of any of clauses 73 to 81, wherein: one or more frequency hops of the RS results in a bandwidth overlap between two or more RS transmissions; and the aggregated bandwidth is based on a sum of the bandwidths of the RS transmissions over the different frequency ranges which is reduced by a bandwidth amount corresponding to a total bandwidth overlap between the two or more RS transmissions.

Clause 83. The non-transitory computer-readable medium of any of clauses 73 to 82, wherein: each RS transmission has a common bandwidth; one or more frequency hops of the RS results in a bandwidth overlap between two or more RS transmissions; and the aggregated bandwidth is based on a multiple M of the common bandwidth reduced by a bandwidth amount corresponding to a total bandwidth overlap between the two or more RS transmissions, wherein M is a number of RS frequency hops for the positioning session.

Clause 84. The non-transitory computer-readable medium of any of clauses 73 to 83, further comprising computer-executable instructions that, when executed by the UE, cause the UE to: report the group delay margin to a location server.

Clause 85. The non-transitory computer-readable medium of any of clauses 73 to 84, further comprising computer-executable instructions that, when executed by the UE, cause the UE to: report a reduced group delay margin based on an actual group delay margin at the UE being less than the first group delay margin or the second group delay margin.

Clause 86. The non-transitory computer-readable medium of any of clauses 73 to 85, further comprising computer-executable instructions that, when executed by the UE, cause the UE to: report an indication that the second group delay margin exceeds a maximum group delay margin tolerance for the positioning session.

Clause 87. A non-transitory computer-readable medium storing computer-executable instructions that, when executed by a user equipment (UE), cause the UE to: receive a configuration for transmitting or receiving multiple reference signals (RS) during a positioning session based on frequency hopping the RS to different frequency ranges; determine a tuned bandwidth of the UE for transmitting or receiving the RS; transmit, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and transmit, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

Clause 88. The non-transitory computer-readable medium of clause 87, wherein: each group delay margin GD(i) of the set of preconfigured group delay margins is associated with a corresponding bandwidth range BW(i).

Clause 89. The non-transitory computer-readable medium of clause 88, wherein; the first group delay margin is a preconfigured group delay margin associated with a bandwidth range corresponding to the tuned bandwidth.

Clause 90. The non-transitory computer-readable medium of any of clauses 88 to 89, wherein: the second group delay margin is determined as a multiple N of a group delay margin GD(max) associated with a bandwidth range BW(max) corresponding to a maximum bandwidth to which the UE is tuned to receive the RS during the positioning session.

Clause 91. The non-transitory computer-readable medium of any of clauses 87 to 90, wherein: the multiple reference signals are uplink sounding reference signals (SRS) transmitted by the UE.

Clause 92. The non-transitory computer-readable medium of any of clauses 87 to 90, wherein: the multiple reference signals are downlink positioning reference signals (PRS) measured at the UE.

Clause 93. The non-transitory computer-readable medium of any of clauses 87 to 92, wherein: the second group delay margin is based on a multiple N of the preconfigured group delay margin associated with the tuned bandwidth, wherein N corresponds to a number of frequency hops of the RS during the positioning session.

Clause 94. The non-transitory computer-readable medium of any of clauses 87 to 93, wherein: each RS transmission has a common bandwidth when transmitted over each frequency range of the different frequency ranges; and the aggregated bandwidth is based on a multiple M of the common bandwidth, wherein M is a number of RS transmissions for the positioning session.

Clause 95. The non-transitory computer-readable medium of any of clauses 87 to 94, wherein: one or more of frequency hops of the RS results in a bandwidth overlap between two or more RS transmissions; and the aggregated bandwidth is based on a sum of the bandwidths of the RS transmissions over the different frequency ranges which is reduced by a bandwidth amount corresponding to a total bandwidth overlap between the two or more RS transmissions.

Clause 96. The non-transitory computer-readable medium of any of clauses 87 to 95, wherein: each RS transmission has a common bandwidth; one or more frequency hops of the RS results in a bandwidth overlap between two or more RS transmissions; and the aggregated bandwidth is based on a multiple M of the common bandwidth reduced by a bandwidth amount corresponding to a total bandwidth overlap between the two or more RS transmissions, wherein M is a number of RS frequency hops for the positioning session.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g. UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a user equipment (UE), comprising:
determining an aggregated bandwidth corresponding to a total bandwidth of multiple reference signals (RS) transmitted based on frequency hopping the RS to different frequency ranges during a positioning session;
determining a tuned bandwidth of the UE for transmitting or receiving the RS; determining, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth;
determining, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and
transmitting or measuring the multiple RS based on the first group delay margin or the second group delay margin for the positioning session.

2-14. (canceled)

15. A method of wireless communication performed by a user equipment (UE), comprising:
receiving a configuration for transmitting or receiving multiple reference signals (RS) during a positioning session based on frequency hopping the RS to different frequency ranges;
determining a tuned bandwidth of the UE for transmitting or receiving the RS; transmitting, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and
transmitting, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

16-24. (canceled)

25. A user equipment (UE), comprising:
a memory;
at least one transceiver; and
at least one processor communicatively coupled to the memory and the at least one transceiver, the at least one processor configured to:
determine an aggregated bandwidth corresponding to a total bandwidth of multiple reference signals (RS) transmitted based on frequency hopping the RS to different frequency ranges during a positioning session;
determine a tuned bandwidth of the UE for transmitting or receiving the RS;
determine, as a group delay margin for the positioning session, a first group delay margin from a set of preconfigured group delay margins based on the tuned bandwidth being less than or equal to the aggregated bandwidth, wherein the first group delay margin is based on a preconfigured group delay margin of the set of preconfigured group delay margins corresponding to the tuned bandwidth;
determine, as the group delay margin for the positioning session, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth; and
transmit, via the at least one transceiver, or measuring the multiple RS based on the first group delay margin or the second group delay margin for the positioning session.

26. The UE of claim 25, wherein:
each group delay margin GD(i) of the set of preconfigured group delay margins is associated with a corresponding RS bandwidth range BW(i).

27. The UE of claim 26, wherein:
the first group delay margin is a preconfigured group delay margin associated with a bandwidth range corresponding to the tuned bandwidth.

28. The UE of claim 26, wherein:
the second group delay margin is determined as a multiple N of a group delay margin GD(max) associated with a bandwidth range BW(max) corresponding to a maximum bandwidth to which the UE is tuned to receive the RS during the positioning session.

29. The UE of claim 25, wherein:
the set of preconfigured group delay margins is specified for a peak bandwidth supported by the UE.

30. The UE of claim 25, wherein:
the set of preconfigured group delay margins includes one or more preconfigured group delay margins each corresponding to a preconfigured bandwidth range, wherein the preconfigured bandwidth range correspond to a bandwidth of the RS at each frequency hop.

31. The UE of claim 25, wherein:
the UE is configured to be tuned multiple times to receive the RS during the positioning session.

32. The UE of claim 25, wherein:
the second group delay margin is based on a multiple N of the preconfigured group delay margin associated with the tuned bandwidth, wherein N corresponds to a number of frequency hops of the RS during the positioning session.

33. The UE of claim 25, wherein:
each RS transmission has a common bandwidth when transmitted over each frequency range of the different frequency ranges; and
the aggregated bandwidth is based on a multiple M of the common bandwidth, wherein M is a number of RS transmissions for the positioning session.

34. The UE of claim 25, wherein:
one or more frequency hops of the RS results in a bandwidth overlap between two or more RS transmissions; and
the aggregated bandwidth is based on a sum of the bandwidths of the RS transmissions over the different frequency ranges which is reduced by a bandwidth amount corresponding to a total bandwidth overlap between the two or more RS transmissions.

35-38. (canceled)

39. A user equipment (UE), comprising:
a memory;
at least one transceiver; and
at least one processor communicatively coupled to the memory and the at least one transceiver, the at least one processor configured to:
receive, via the at least one transceiver, a configuration for transmitting or receiving multiple reference signals (RS) during a positioning session based on frequency hopping the RS to different frequency ranges;
determine a tuned bandwidth of the UE for transmitting or receiving the RS;
transmit, via the at least one transceiver, to a location server, an indication of a first group delay margin from a set of preconfigured group delay margins based on the tuned bandwidth being less than or equal to an aggregated bandwidth corresponding to a total bandwidth of the multiple RS transmitted over the different frequency ranges, wherein the first group delay margin is based on a preconfigured group delay margin of the set of preconfigured group delay margins corresponding to the tuned bandwidth; and
transmit, via the at least one transceiver, to the location server, a second group delay margin based on the aggregated bandwidth being greater than the tuned bandwidth, wherein the second group delay margin is based on a sum of preconfigured group delay margins associated with bandwidths to which the UE is tuned to transmit or receive the RS over the aggregated bandwidth.

40. The UE of claim 39, wherein:
each group delay margin GD(i) of the set of preconfigured group delay margins is associated with a corresponding bandwidth range BW(i).

41. The UE of claim 40, wherein:
the first group delay margin is a preconfigured group delay margin associated with a bandwidth range corresponding to the tuned bandwidth.

42. The UE of claim 40, wherein:
the second group delay margin is determined as a multiple N of a group delay margin GD(max) associated with a bandwidth range BW(max) corresponding to a maximum bandwidth to which the UE is tuned to receive the RS during the positioning session.

43. The UE of claim 39, wherein:
the multiple reference signals are uplink sounding reference signals (SRS) transmitted by the UE.

44. The UE of claim 39, wherein:
the multiple reference signals are downlink positioning reference signals (PRS) measured at the UE.

45. The UE of claim 39, wherein:
the second group delay margin is based on a multiple N of the preconfigured group delay margin associated with the tuned bandwidth, wherein N corresponds to a number of frequency hops of the RS during the positioning session.

46. The UE of claim 39, wherein:
each RS transmission has a common bandwidth when transmitted over each frequency range of the different frequency ranges; and
the aggregated bandwidth is based on a multiple M of the common bandwidth, wherein M is a number of RS transmissions for the positioning session.

47-52. (canceled)
